(19) United States
(12) Patent Application Publication
(10) Pub. No.: US 2026/0307814 A1
(43) Pub. Date: Oct. 8, 2026

(54) SPATIAL PYLONS FOR MOUNTING A GAS TURBINE ENGINE

(71) Applicant: General Electric Company, Evendale, OH (US)

(72) Inventors: Amir Nasrollahi, Evendale, OH (US); Neil Christian Wilhelmus, Highland Heights, KY (US); Mahesh Khandeparker, Bangalore (IN); Jason Holden, Cincinnati, OH (US); Timothy L. Schelfaut, Lebanon, OH (US); Jonathan E. Coleman, Mason, OH (US); Swatantra Singh, Gorakhpur (IN)

(21) Appl. No.: 19/638,396

(22) Filed: Apr. 3, 2026

(30) Foreign Application Priority Data
Apr. 3, 2025 (IN) 202511032888

(51) Int. Cl. B64D 27/40; B64D 27/18

(52) U.S. Cl. CPC B64D 27/402; B64D 27/18

(57) ABSTRACT

Spatial pylons for mounting a gas turbine engine are disclosed herein. An example apparatus to couple a gas turbine engine to an aircraft disclosed herein includes a first mount to be coupled to a first frame portion of the gas turbine engine, a second mount to be coupled to a second frame portion of the gas turbine engine, a third mount to be coupled to the gas turbine engine, a main rail extending between the first mount and the second mount, and a circumferential member coupled to the main rail and the third mount.

### CROSS-REFERENCE TO RELATED APPLICATION

This application claims priority to Indian Provisional Application Number 202511032888, filed Apr. 3, 2025, which is incorporated by reference in its entirety herein for all purposes.

### FIELD OF THE DISCLOSURE

This disclosure relates generally to gas turbine engines and, more particularly, to spatial pylons for mounting a gas turbine engine.

### BACKGROUND

A gas turbine engine generally includes, in serial flow order, an inlet section, a compressor section, a combustion section, a turbine section, and an exhaust section. In operation, air enters the inlet section and flows to the compressor section where one or more axial compressors progressively compress the air until it reaches the combustion section, thereby creating combustion gases. The combustion gases flow from the combustion section through a hot gas path defined within the turbine section and then exit the turbine section via the exhaust section.

### BRIEF DESCRIPTION OF THE DRAWINGS

FIG. 1 is a cross-sectional view of an example turbofan gas turbine engine in which examples disclosed herein may be implemented.

FIG. 2 is a cross-sectional view of an example open rotor engine in which examples disclosed herein may be implemented.

FIG. 3A is a schematic side view of a gas turbine engine and an example first spatial pylon implemented in accordance with teachings of this disclosure.

FIG. 3B is a schematic side view of the gas turbine engine and first spatial pylon of FIG. 3A mounted to a wing in a first configuration.

FIG. 3C is a schematic side view of the gas turbine engine and first spatial pylon of FIG. 3A mounted to a wing in a second configuration.

FIG. 3D is an example illustration of a gas turbine engine mounted to a wing using a spatial pylon.

FIG. 4A is a schematic side view of a gas turbine engine and an example second spatial pylon implemented in accordance with teachings of this disclosure.

FIG. 4B is a schematic side view of a gas turbine engine and an example third spatial pylon implemented in accordance with teachings of this disclosure.

FIG. 4C is a schematic side view of a gas turbine engine and an example fourth spatial pylon implemented in accordance with teachings of this disclosure.

FIG. 5 is an example top view of an example fifth spatial pylon implemented in accordance with teachings of this disclosure.

FIG. 6A is a schematic side view of the first gas turbine engine and the first spatial pylon of FIG. 3A, including an example first harness implemented in accordance with teachings of this disclosure.

FIG. 6B is a schematic side view of the first gas turbine engine and the first spatial pylon of FIG. 3A, including an example second harness implemented in accordance with teachings of this disclosure.

FIG. 6C is a schematic side view of the first gas turbine engine and the first spatial pylon of FIG. 3A, including an example third harness implemented in accordance with teachings of this disclosure.

FIG. 7A is a schematic side view of a gas turbine engine and an example first partial spatial pylon implemented in accordance with teachings of this disclosure.

FIG. 7B is a schematic side view of a gas turbine engine and an example second partial spatial pylon implemented in accordance with teachings of this disclosure.

FIG. 7C is a schematic side view of a gas turbine engine and an example third partial spatial pylon implemented in accordance with teachings of this disclosure.

FIG. 8A is a schematic side view of a gas turbine engine, an airframe, and an example sixth spatial pylon implemented in accordance with teachings of this disclosure.

FIG. 8B is a schematic side view of a gas turbine engine, an airframe and an example seventh spatial pylon implemented in accordance with teachings of this disclosure.

The figures are not to scale. Instead, the thickness of the layers or regions may be enlarged in the drawings. Although the figures show layers and regions with clean lines and boundaries, some or all of these lines and/or boundaries may be idealized.

### DETAILED DESCRIPTION

Prior pylons are rigid boxes that couple a gas turbine engine to an aircraft. Prior box pylons face many shortcomings for next-generation gas turbine engine architectures, such as open fan engines. Particularly, prior box pylons have limited practical mounts’ connection points to the gas turbine engine, which can make the gas turbine engine difficult to access for maintenance and have lower efficiency. These shortcomings can increase the total weight of the gas turbine engine, cause large drag loads, and increase core closures associated with engine bending moments. Examples disclosed herein include spatial pylons for mounting a gas turbine engine to an aircraft.

In certain examples, the pylon is a spatial lattice-type structure (a spatial pylon) that can wrap around the engine and have mount components embedded in the spatial structure. Such configurations allow for more flexibility on the location of the mount joints on the engine forward, mid, and turbine frames. By embedding the upper half of the engine in the pylon, the ground clearance increases using the proposed pylon. The ease of maintainability and engine removal from the wing is another benefit of the spatial pylon. Design of the spatial pylon can be modified based on topology and size optimization to minimize or otherwise reduce the weight and tune the stiffness of the pylon.

The spatial pylons disclosed herein include a lattice of structural members. Some example spatial pylons disclosed herein include flexible harnesses, which reduce the bending associated with the gas turbine engine. In some examples disclosed herein, the spatial pylon partially surrounds the gas turbine engine, which enables the sides of the gas turbine engine to be mounted to the pylon and increases the ground clearance of the gas turbine engine. Such a spatial pylon or “cradle” mount can be configured (e.g., designed, etc.) to have a comparatively lower weight (e.g., higher fuel efficiency, etc.) than prior box pylons, while maintaining the design requirements of the gas turbine engine (e.g., strength requirements, life/durability requirements, performance requirements, manufacturability requirements, maintainability requirements, etc.).

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized. The following detailed description is therefore provided to describe example implementations and not to be taken limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object.

The terms “upstream” and “downstream” refer to the relative direction with respect to fluid flow in a fluid pathway. For example, “upstream” refers to the direction from which the fluid flows, and “downstream” refers to the direction to which the fluid flows.

In some examples used herein, the term “substantially” is used to describe a relationship between two parts that is within three degrees of the stated relationship (e.g., a substantially collinear relationship is within three degrees of being linear, a substantially perpendicular relationship is within three degrees of being perpendicular, a substantially parallel relationship is within three degrees of being parallel, etc.).

As used herein, the terms “axial” and “longitudinal” both refer to a direction parallel to the centerline axis of a gas turbine (e.g., a turbofan, a core gas turbine engine, etc.), while “radial” refers to a direction perpendicular to the axial direction, and “tangential” or “circumferential” refers to a direction mutually perpendicular to the axial and radial directions. Accordingly, as used herein, “radially inward” refers to the radial direction from the outer circumference of the gas turbine towards the centerline axis of the gas turbine, and “radially outward” refers to the radial direction from the centerline axis of the gas turbine towards the outer circumference of the gas turbine. As used herein, the terms “forward”, “fore”, and “front” refer to a location relatively upstream in an air flow passing through or around a component, and the terms “aft” and “rear” refer to a location relatively downstream in an air flow passing through or around a component.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase "at least" is used as the transition term in, for example, a preamble of a claim, it is open-ended in the same manner as the term "comprising" and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase "at least one of A and B" is intended to refer to implementations including any of (1) at least one A, (2) at least one B, and (3) at least one A and at least one B. Similarly, as used herein in the context of describing structures, components, items, objects and/or things, the phrase "at least one of A or B" is intended to refer to implementations including any of (1) at least one A, (2) at least one B, and (3) at least one A and at least one B. As used herein in the context of describing the performance or execution of processes, instructions, actions, activities and/or steps, the phrase "at least one of A and B" is intended to refer to implementations including any of (1) at least one A, (2) at least one B, and (3) at least one A and at least one B. Similarly, as used herein in the context of describing the performance or execution of processes, instructions, actions, activities and/or steps, the phrase "at least one of A or B" is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Some gas turbine engines are mounted to aircraft wings or fuselages via pylons. Pylons are structural components that transfer the loads associated with gas turbine engines (e.g., thrust loads, aerodynamic loads, gravity loads, etc.) to the body of the aircraft. Gas turbine engines are coupled to the pylons at one or more locations via mountings. One type of prior pylon is a box pylon. Box pylons typically include a rigid shell (e.g., a box, etc.) that is contained within a faring, which reduces the drag associated with a box pylon. Box pylons have several design limitations. For example, box pylons often have short wheelbases between the front and aft mounts of the gas turbine engine. Box pylons also require large fairings and nacelle lines, which have negative effects on the performance of the aircraft that include box pylons (e.g., increased drag, increased weight, etc.). Additionally, box pylons can reduce accessibility to the gas turbine engine due to physical obstruction by the shell of the box pylon. Box pylons can also increase carcass bending and engine clearances, which reduces engine efficiency. Prior efforts to mitigate these shortcomings, such as additional and/or heavier mounting components, increase the weight of gas turbine engines and can cause the mounting of the gas turbine engine to be statically indeterminate, which increases thermal loads on the gas turbine engine. These limitations can limit the design space of gas turbine engines, particularly with next-generation engine architectures like open fan engines and/or gas turbine engines with cantilevered cores.

Examples disclosed herein include spatial pylons that mitigate some or all of the above-noted limitations. Example pylons disclosed herein include spatial lattice pylons that partially wrap around gas turbine engines and include embedded mounting components. Some example spatial pylons disclosed herein include stiff membranes that extend between the structural members of the lattice. Some example spatial pylons disclosed herein include harnesses, which increase the stiffness of the gas turbine engine. Some example spatial pylons disclosed herein are partial spatial pylons that include structural members coupled to a box pylon. Example spatial pylons and mount systems disclosed herein reduce system weight, reduce engine footprint, increase ground clearance by enabling the gas turbine engines to be mounted closer to a wing of an aircraft, and provide reduced core closures when compared to prior box pylons. Example spatial pylons disclosed herein offer additional design flexibility for the placement of engine mounts on the pylon. Example spatial pylons disclosed herein also facilitate the maintenance of gas turbine engines by increasing the ease of removing a gas turbine engine and the ease of accessing the interior of a gas turbine engine.

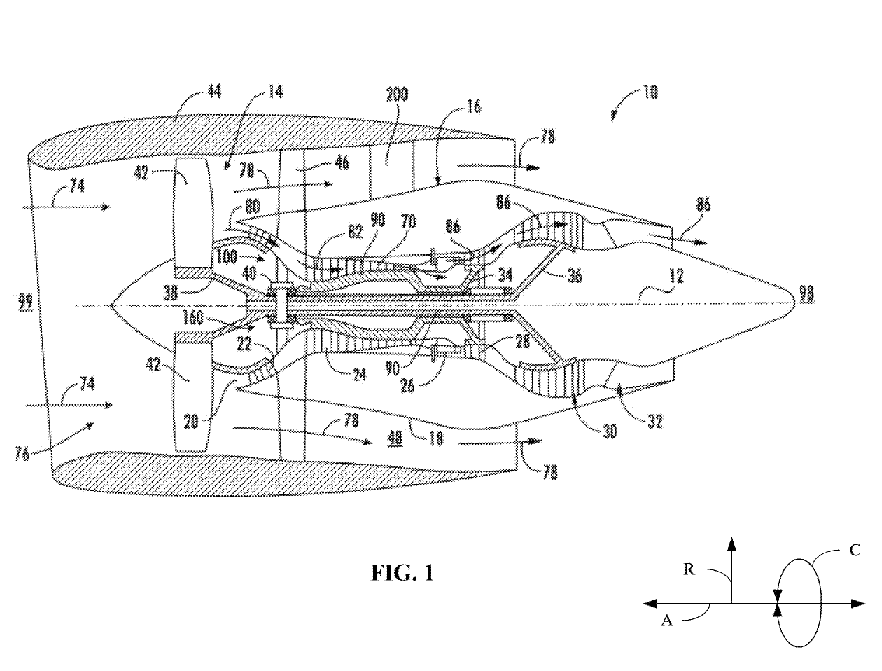

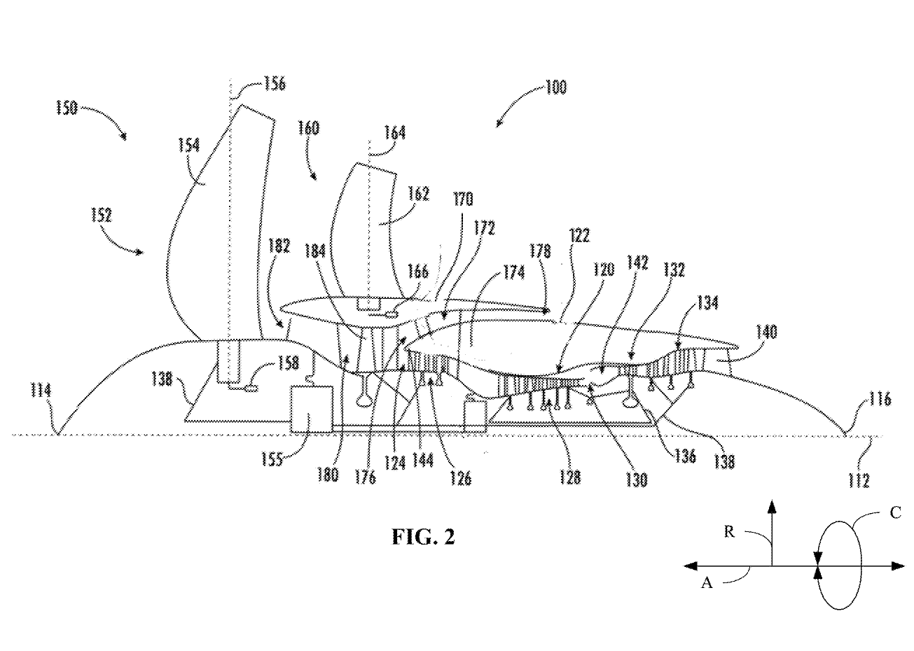

Examples disclosed herein can be applied to any gas turbine engine design, such as closed-rotor engines (e.g., turbofans, turbojets, etc.), open rotor engines (e.g., open fan engines, etc.), turboshaft engines, turboprops, etc. For purposes of illustration only, FIG. 1 illustrates an example closed-rotor turbofan engine, and FIG. 2 illustrates an example open-rotor engine.

FIG. 1 is a cross-sectional view of a turbofan gas turbine engine in which examples disclosed herein may be implemented. Referring now to the drawings, FIG. 1 is a schematic partially cross-sectioned side view of a gas turbine engine 10 as may incorporate various examples of the present disclosure. The gas turbine engine 10 may particularly be configured as a gas turbine engine for an aircraft. Although further described herein as a turbofan engine, the gas turbine engine 10 may define a turboshaft, turboprop, or turbojet gas turbine engine, including marine and industrial engines and auxiliary power units. As shown in FIG. 1, the gas turbine engine 10 has a longitudinal or axial centerline 12 that extends therethrough for reference purposes. An axial direction A is extended co-directional to the axial centerline 12 for reference. The gas turbine engine 10 further defines an upstream end 99 and a downstream end 98 for reference. In general, the gas turbine engine 10 may include a fan assembly 14 and a core engine 16 disposed downstream from the fan assembly 14. For reference, the gas turbine engine 10 defines an axial direction A, a radial direction R, and a circumferential direction C. In general, the axial direction A extends parallel to the axial centerline 12, the radial direction R extends outward from and inward to the axial centerline 12 in a direction orthogonal to the axial direction A, and the circumferential direction extends three hundred sixty degrees (360°) around the axial centerline 12.

The core engine 16 may generally include an outer casing 18 that defines an annular inlet 20. In FIG. 1, the outer casing 18 is substantially tubular. The outer casing 18 encases or at least partially forms, in serial flow relationship, a compressor section having a booster or low pressure (LP) compressor 22, a high pressure (HP) compressor 24, a heat addition system 26, an expansion section or turbine section including a high pressure (HP) turbine 28, a low pressure (LP) turbine 30 and a jet exhaust nozzle section 32. A high pressure (HP) rotor shaft 34 drivingly connects the HP turbine 28 to the HP compressor 24. A low pressure (LP) rotor shaft 36 drivingly connects the LP turbine 30 to the LP compressor 22. The LP rotor shaft 36 may also be connected to a fan shaft 38 of the fan assembly 14. In certain examples, as shown in FIG. 1, the LP rotor shaft 36 may be connected to the fan shaft 38 via a reduction gear 40 such as in an indirect-drive or geared-drive configuration.

As shown in FIG. 1, the fan assembly 14 includes a plurality of fan blades 42 that are coupled to and that extend radially outwardly from the fan shaft 38. An annular fan casing or nacelle 44 circumferentially may surround the fan assembly 14 and/or at least a portion of the core engine 16. It should be appreciated by those of ordinary skill in the art that the nacelle 44 may be configured to be supported relative to the core engine 16 by a plurality of circumferentially-spaced outlet guide vanes or struts 46. Moreover, at least a portion of the nacelle 44 may extend over an outer portion of the core engine 16 so as to define a fan flow passage 48 therebetween. However, it should be appreciated that various configurations of the gas turbine engine 10 may omit the nacelle 44, or omit the nacelle 44 from extending around the fan blades 42, such as to provide an open rotor or propfan configuration of the gas turbine engine 10 depicted in FIG. 2.

It should be appreciated that combinations of the HP rotor shaft 34, the LP rotor shaft 36, the LP compressor 22, the HP compressor 24, the HP turbine 28, and the LP turbine 30 define a rotor assembly 90 of the gas turbine engine 10. For example, the HP rotor shaft 34, HP compressor 24, and HP turbine 28 may define a high speed or HP rotor assembly of the gas turbine engine 10. Similarly, combinations of the LP rotor shaft 36, LP compressor 22, and LP turbine 30 may define a low speed or LP rotor assembly of the gas turbine engine 10. Various examples of the gas turbine engine 10 may further include the fan shaft 38 and fan blades 42 as the LP rotor assembly. In certain examples, the gas turbine engine 10 may further define a fan rotor assembly at least partially mechanically de-coupled from the LP spool via the fan shaft 38 and the reduction gear 40. Still further examples may further define one or more intermediate rotor assemblies defined by an intermediate pressure compressor, an intermediate pressure shaft, and an intermediate pressure turbine disposed between the LP rotor assembly and the HP rotor assembly (relative to serial aerodynamic flow arrangement).

During operation of the gas turbine engine 10, a flow of air 74, shown schematically by arrows, enters an inlet 76 of the gas turbine engine 10 defined by the fan case or nacelle 44. A portion of air 80, shown schematically by arrows, enters the core engine 16 through an annular inlet 20 defined at least partially via the outer casing 18. The flow of air is provided in serial flow through the compressors, the heat addition system, and the expansion section via a core flow path 70. The flow of compressed air 82 is increasingly compressed as it flows across successive stages of the LP compressor 22 and the HP compressor 24, such as shown schematically by arrows. The compressed air 82 enters the heat addition system 26 and mixes with a liquid and/or gaseous fuel and is ignited to produce combustion gases 86. It should be appreciated that the heat addition system 26 may form any appropriate system for generating combustion gases, including, but not limited to, deflagrative or detonative combustion systems, or combinations thereof. The heat addition system 26 may include annular, can, can-annular, trapped vortex, involute or scroll, rich burn, lean burn, rotating detonation, or pulse detonation configurations, or combinations thereof.

The combustion gases 86 release energy to drive rotation of the HP rotor assembly and the LP rotor assembly before exhausting from the jet exhaust nozzle section 32. The release of energy from the combustion gases 86 further drives rotation of the fan assembly 14, including the fan blades 42. A portion of the air 74 bypasses the core engine 16 and flows across the fan flow passage 48, such as shown schematically by arrows 78.

It should be appreciated that FIG. 1 depicts and describes a two-stream engine having the fan flow passage 48 and the core flow path 70. The example depicted in FIG. 1 has a nacelle 44 surrounding the fan blades 42, such as to provide noise attenuation, blade-out protection, and/or other benefits known for nacelles, and which may be referred to herein as a “ducted fan,” or the entirety of the gas turbine engine 10 may be referred to as a “ducted engine.”

FIG. 2 is a schematic cross-sectional view of an example open-rotor turbine engine according to one example of the present disclosure. Particularly, FIG. 2 illustrates an aviation three-stream turbofan engine herein referred to as “three-stream engine 100”. The three-stream engine 100 of FIG. 2 can be mounted to an aerial vehicle, such as a fixed-wing aircraft, and can produce thrust for propulsion of the aerial vehicle. The architecture of the three-stream engine 100 provides three distinct streams of thrust-producing airflow during operation. Unlike the gas turbine engine 10 shown in FIG. 1, the three-stream engine 100 includes a fan that is not ducted by a nacelle or cowl, such that it may be referred to herein as an “unducted fan,” or the entirety of the three-stream engine 100 may be referred to as an “unducted engine.”

For reference, the three-stream engine 100 defines an axial direction A, a radial direction R, and a circumferential direction C. Moreover, the three-stream engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The three-stream engine 100 extends between a forward end 114 and an aft end 116, e.g., along the axial direction A.

The three-stream engine 100 includes a core engine 120 and a fan section 150 positioned upstream thereof. Generally, the core engine 120 includes, in serial flow order, a compressor section, a combustion section, a turbine section, and an exhaust section. Particularly, as shown in FIG. 2, the core engine 120 includes a core cowl 122 that defines an annular core inlet 124. The core cowl 122 further encloses a low pressure system and a high pressure system. In certain examples, the core cowl 122 may enclose and support a booster or low pressure (“LP”) compressor 126 for pressurizing the air that enters the core engine 120 through core inlet 124. A high pressure (“HP”), multi-stage, axial-flow compressor 128 receives pressurized air from the LP compressor 126 and further increases the pressure of the air. The pressurized air stream flows downstream to a combustor 130 where fuel is injected into the pressurized air stream and ignited to raise the temperature and energy level of the pressurized air. It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems and are not meant to imply any absolute speed and/or pressure values.

The high energy combustion products flow from the combustor 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example. After driving each of the LP turbine 132 and the HP turbine 134, the combustion products exit the core engine 120 through a core exhaust nozzle 140 to produce propulsive thrust. Accordingly, the core engine 120 defines a core flow path or core duct 142 that extends between the core inlet 124 and the core exhaust nozzle 140. The core duct 142 is an annular duct positioned generally inward of the core cowl 122 along the radial direction R.

The fan section 150 includes a fan 152, which is the primary fan in this example. For the depicted example of FIG. 2, the fan 152 is an open rotor or unducted fan. However, in other examples, the fan 152 may be ducted, e.g., by a fan casing or nacelle circumferentially surrounding the fan 152. As depicted, the fan 152 includes an array of fan blades 154 (only one shown in FIG. 2). The fan blades 154 are rotatable, e.g., about the longitudinal axis 112. As noted above, the fan 152 is drivingly coupled with the low pressure turbine 134 via the LP shaft 138. The fan 152 can be directly coupled with the LP shaft 138, e.g., in a direct-drive configuration. Optionally, as shown in FIG. 2, the fan 152 can be coupled with the LP shaft 138 via a speed reduction gearbox 155, e.g., in an indirect-drive or a geared-drive configuration.

Moreover, the fan blades 154 can be arranged in equal spacing around the longitudinal axis 112. Each blade 154 has a root and a tip and a span defined therebetween. Each blade 154 defines a central blade axis 156. For this example, each blade 154 of the fan 152 is rotatable about its respective central blade axes 156, e.g., in unison with one another. One or more actuators 158 can be controlled to pitch the blades 154 about their respective central blade axes 156. However, in other examples, each blade 154 may be fixed or unable to be pitched about its central blade axis 156.

The fan section 150 further includes a fan guide vane array 160 that includes fan guide vanes 162 (only one shown in FIG. 2) disposed around the longitudinal axis 112. For this example, the fan guide vanes 162 are not rotatable about the longitudinal axis 112. Each fan guide vane 162 has a root and a tip and a span defined therebetween. The fan guide vanes 162 may be unshrouded as shown in FIG. 2 or may be shrouded, e.g., by an annular shroud spaced outward from the tips of the fan guide vanes 162 along the radial direction R. Each fan guide vane 162 defines a central blade axis 164. For this example, each fan guide vane 162 of the fan guide vane array 160 is rotatable about its respective central blade axes 164, e.g., in unison with one another. One or more actuators 166 can be controlled to pitch the fan guide vane 162 about their respective central blade axes 164. However, in other examples, each fan guide vane 162 may be fixed or unable to be pitched about its central blade axis 164. The fan guide vanes 162 are mounted to a fan cowl 170.

As shown in FIG. 2, in addition to the fan 152, which is unducted, a ducted fan 184 is included aft of the fan 152, such that the three-stream engine 100 includes both a ducted and an unducted fan that both serve to generate thrust through the movement of air without passage through core engine 120. The ducted fan 184 is shown at about the same axial location as the fan guide vane 162, and radially inward of the fan guide vane 162. Alternatively, the ducted fan 184 may be between the fan guide vane 162 and core duct 142, or be farther forward of the fan guide vane 162. The ducted fan 184 may be driven by the low pressure turbine 134 (e.g., coupled to the LP shaft 138), or by any other suitable source of rotation, and may serve as the first stage of booster or may be operated separately.

The fan cowl 170 annularly encases at least a portion of the core cowl 122 and is generally positioned outward of the core cowl 122 along the radial direction R. Particularly, a downstream section of the fan cowl 170 extends over a forward portion of the core cowl 122 to define a fan flow path or fan duct 172. Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The stationary struts 174 may each be aerodynamically contoured to direct air flowing thereby. Other struts in addition to the stationary struts 174 may be used to connect and support the fan cowl 170 and/or core cowl 122. In many examples, the fan duct 172 and the core cowl 122 may at least partially co-extend (generally axially) on opposite sides (e.g., opposite radial sides) of the core cowl 122. For example, the fan duct 172 and the core cowl 122 may each extend directly from the leading edge 144 of the core cowl 122 and may partially co-extend generally axially on opposite radial sides of the core cowl.

The three-stream engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a splitter or leading edge 144 of the core cowl 122. The inlet duct 180 is wider than the core duct 142 along the radial direction R. The inlet duct 180 is also wider than the fan duct 172 along the radial direction R.

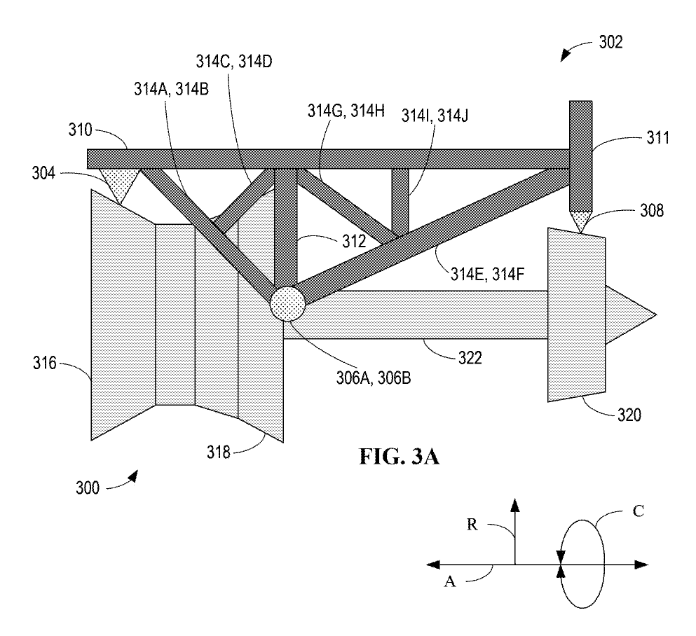

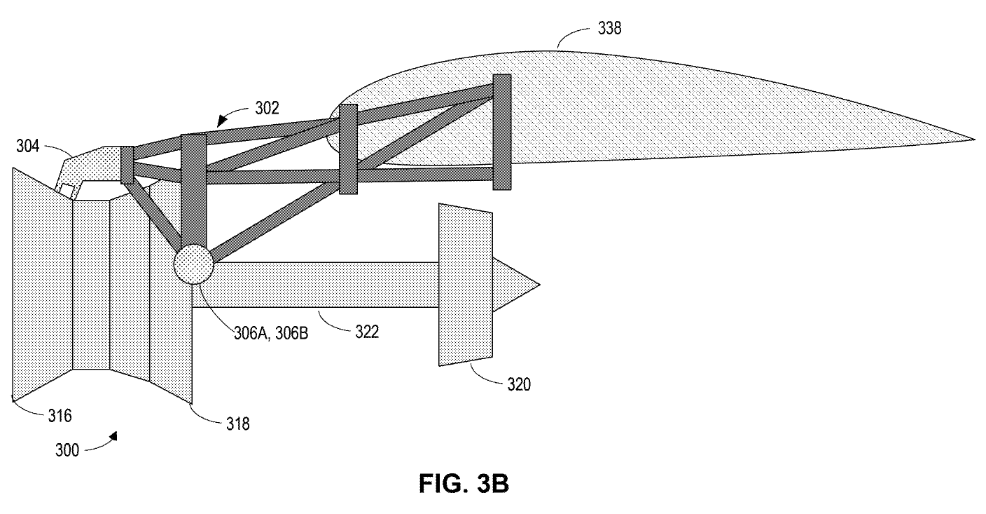

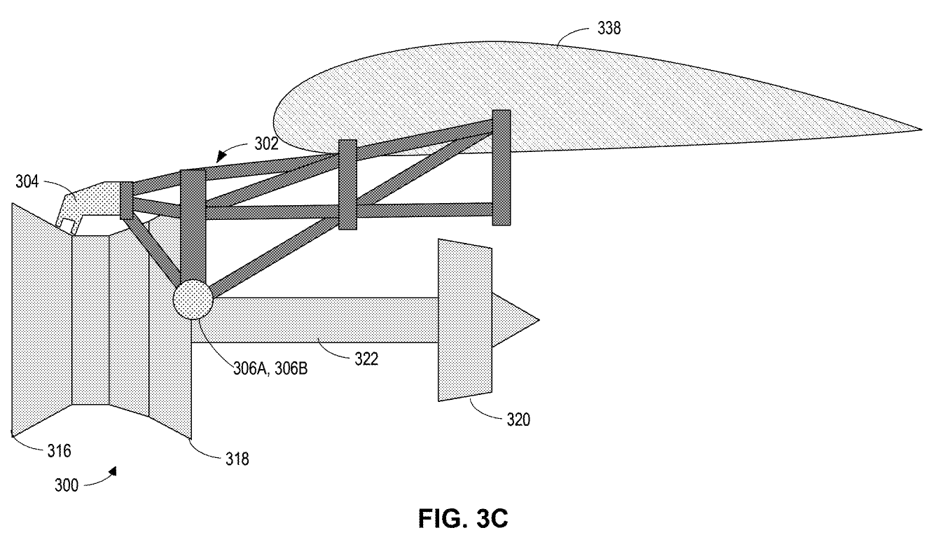

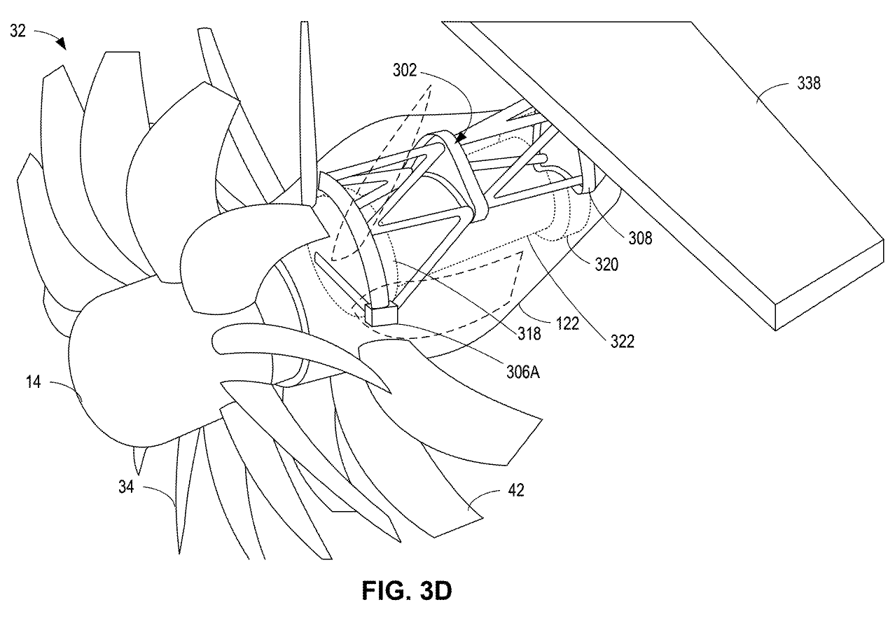

FIG. 3A is a schematic side view of a gas turbine engine 300 and an example first spatial pylon 302 implemented in accordance with teachings of this disclosure. In the illustrated example of FIG. 3A, the first spatial pylon 302 includes a front mount 304 (e.g., a first mount), a first middle mount 306A (e.g., a second mount, etc.), a second middle mount 306B (e.g., a third mount, etc.), and an aft mount 308 (e.g., a fourth mount, etc.). In the illustrated example of FIGS. 3A and 3B, the first spatial pylon 302 includes a top rail 310, an aft member 311, a circumferential member 312, a first arm 314A, a second arm 314B, a third arm 314C, a fourth arm 314D, a fifth arm 314E, a sixth arm 314F, a seventh arm 314G, an eighth arm 314H, a ninth arm 314I, and a tenth arm 314J. As used herein, the terms “arm” and “member” are used interchangeably to refer to rigid structural members that mechanically couple to locations of a spatial pylon. As used herein, the top rail 310 is also interchangeably referred to as a “main rail.”

The gas turbine engine 300 of FIG. 3A can be implemented by any type of gas turbine engine, such as the gas turbine engine 10 of FIG. 1 and/or the three-stream engine 100 of FIG. 2. In the illustrated example of FIG. 3A, the gas turbine engine 300 is coupled to the first spatial pylon 302 via the mounts 304, 306A, 306B, 308. Particularly, the gas turbine engine 300 includes a front frame portion 316 that is coupled to the top rail 310 of the first spatial pylon 302 via the front mount 304. The gas turbine engine 300 includes a middle frame portion 318 that is coupled to the circumferential member 312, the first arm 314A, and the third arm 314C of the first spatial pylon 302 via the middle mounts 306A, 306B. The gas turbine engine 300 includes an aft frame portion 320 (e.g., a rear frame portion, etc.) that is coupled to the aft member 311 of the first spatial pylon 302 via the aft mount 308. The gas turbine engine 300 also includes a carcass 322 that extends between the middle frame portion 318 and the aft frame portion 320.

The forward mount 304, the middle mounts 306A, 306B, and the aft mount 308 are mechanical linkages disposed between the gas turbine engine 300 and the first spatial pylon 302. In some examples, some or all of the mounts 304, 306A, 306B, 308 can be implemented by a pin linkage (e.g., a 1-pin linkage, a lug/clevis linkage, a 2-pin linkage, a 3-pin linkage, etc.), a whiffletree linkage, a slotted oval hole, a bolted joint, a swing linkage, and/or other type of linkage or combination thereof. Unlike prior pylons, the first spatial pylon 302 enables the mounts to be positioned on/at any location on the outer diameter of the gas turbine engine 300. That is, the first spatial pylon 302 enables the mounts 304, 306A, 306B, 308 to be positioned anywhere along the circumference of the gas turbine engine 300. For example, the middle mounts 306A, 306B are disposed on the sides of the gas turbine engine 300. For example, the middle mounts 306A, 306B are disposed at the 3 o’clock and the 9 o’clock positions of the gas turbine engine 300 (e.g., relative to the yaw line of the gas turbine engine 300, etc.). In other examples, the middle mounts 306A, 306B can be disposed at other symmetric locations on the gas turbine engine 300 (e.g., the 1 o’clock and the 11 o’clock positions, the 2 o’clock and the 10 o’clock positions, the 7 o’clock and the 5 o’clock positions, etc.). In some examples, the positions of the mounts 306A, 306B are asymmetric (e.g., the 3 o’clock and the 10 o’clock positions, etc.). For example, the forward mount 304 and the aft mount 308 are disposed at the 12 o’clock position. In some examples, the forward mount 304 and the aft mount 308 can be implemented by multiple linkages. In some examples, the linkages of the forward mount 304 and the aft mount 308 can be disposed at different circumferential locations on the gas turbine engine 300 (e.g., similar the middle mounts 306A, 306B, etc.).

The forces and moments generated by the weight and operation of the gas turbine engine 300 are reacted via the mounts 304, 306A, 306B, 308. The mounts 304, 306A, 306B, 308 fully constrain the movement of the gas turbine engine 300. That is, each of the six degrees of freedom (e.g., yaw rotation, pitch rotation, roll rotation, yaw translation, pitch translation, and roll translation, etc.) of the gas turbine engine 300 is reacted via the mounts 304, 306A, 306B, 308. In some examples, the configuration of the mounts 304, 306A, 306B, 308 causes the coupling between the gas turbine engine 300 and the first spatial pylon 302 to be statically determinate. In other examples, the configuration of the mounts 304, 306A, 306B, 308 causes the coupling of the gas turbine engine 300 to the first spatial pylon 302 to be statically overdetermined. In some such examples, the thickness, materials, quantity, and spatial relationship of the members of the first spatial pylon 302 (e.g., the top rail 310, the aft member 311, the circumferential member 312, and the arms 314A, 314B, 314C, 314D, 314E, 314F, 314G, 314H, 314I, 314J, etc.) can be designed to account for the thermal expansion and expected mechanical deformation thereof. In some examples, the first spatial pylon 302 can include one or more failsafe connections (e.g., mechanical fuses, etc.). In some such examples, because the first spatial pylon 302 extends around (e.g., partially around, etc.) the gas turbine engine 300, the failsafe connections of the gas turbine engine 300 can be positioned at more locations than prior pylons (e.g., additional failsafe connections, alternatively failsafe connections that are more favorably positioned, etc.).

In some examples, the mounts 304, 306A, 306B, 308 are arranged in a single plane mounting configuration. For example, all of the mounts 304, 306A, 306B, 308 can be disposed at a single circumferential/radial plane. In such examples, the first spatial pylon 302 reacts each of the yaw, pitch, roll loads and moments at the single circumferential/radial plane. In such examples, the flexibility associated with the first spatial pylon 302 facilitates the placement of each of the mounts 304, 306A, 306B, 308 at a single plane. In the illustrated example of FIG. 3A, the middle mounts 306A, 306B have a same displacement from the main rail 310 and at a same relative height on the gas turbine engine 300. That is, the first middle mount 306A and the second middle mount 306B have a same vertical displacement from the main rail 310 and a same angular displacement from the main rail 310 (e.g., the first middle mount 306A and the second middle mount 306B are both displaced from the main rail 310 by 90 degrees, etc.).

The frame portions 316, 318, 320 are also referred to herein as “casing portions” or “case portions.” In some examples, the forward frame portion 316 includes the portion of the case of the gas turbine engine 300 that houses the turbomachinery components of the fan (e.g., the fan section 106, etc.), the fan frame, and/or the LP compressor of the gas turbine engine 300 (e.g., the LP compressor 22, etc.). In some examples, the middle frame portion 318 includes the core turbomachinery components (e.g., the HP compressor 24, etc.). In some examples, the aft frame portion 320 is the portion of the gas turbine engine 300 that includes the low-pressure turbine (e.g., the LP turbine 30, etc.). In some examples, the forward frame portion 316 corresponds or attaches to a forward portion of the unducted engine 100 aft of the fan section 150 such as the fan cowl 170. In some examples, the middle frame portion 318 corresponds or attaches to an aft portion of the fan cowl 170. In some examples, the aft frame portion 320 corresponds or attaches to an aft portion of the core cowl 122, the aft end 116, etc. As such, the mounts 304, 306A, 306B, 308 of the spatial pylon 302 can attach the engine 10, 100 to the wing of an aircraft via one or more attachment points including a turbine forward frame, a turbine mid frame, a turbine vane frame, a turbine rear frame, a turbine center frame, a fan hub frame, a fan case, etc., for an unducted or ducted engine.

The carcass 322 includes one or more of the HP compressor, the combustor section, and the HP turbine of the gas turbine engine 300. The carcass 322 is also interchangeably referred to as the “core structure.” It should be appreciated that the first spatial pylon 302 is not limited to the gas turbine engine 300 with the configuration of the frame portions 316, 318, 320, and the carcass 322 depicted in FIG. 3A. Instead, the first spatial pylon 302 and other spatial pylons described herein can be used in conjunction with any type of gas turbine engine.

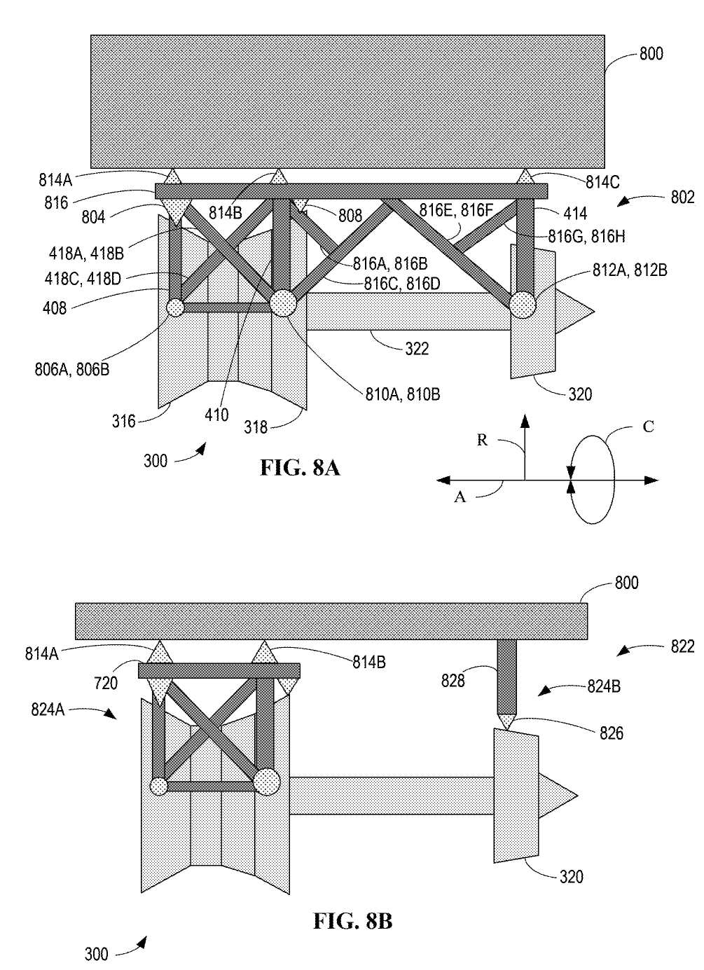

The first spatial pylon 302 is a mechanical structure that couples the gas turbine engine to an aircraft. The first spatial pylon 302 can be coupled to a wing of an aircraft. In other examples, the first spatial pylon 302 can be coupled to a fuselage of an aircraft. The forces and moments generated by the weight and operation of the gas turbine engine 300 (e.g., thrust loads, gravity loads, aerodynamic loads, etc.) are reacted via the mounts 304, 306A, 306B, 308 and transferred to the aircraft via the first spatial pylon 302. In some examples, the first spatial pylon 302 can include a covering (e.g., a faring, etc.) disposed over some or all of the top rail 310, the aft member 311, the circumferential member 312, and the arms 314A, 314B, 314C, 314D. In some such examples, the covering over the first spatial pylon 302 reduces the drag associated with the first spatial pylon 302. Example pylons coupled to a fuselage of an aircraft are described below in conjunction with FIGS. 8A and 8B.

The top rail 310, the aft member 311, the circumferential member 312, and the arms 314A, 314B, 314C, 314D, 314E, 314F, 314G, 314H, 314I, 314J are rigid structural members that support and bear the forces associated with the gas turbine engine 300. In some examples, some or all of the top rail 310, the aft member 311, the circumferential member 312, and the arms 314A, 314B, 314C, 314D, 314E, 314F, 314G, 314H, 314I, 314J are tubular members (e.g., round tubes, square tubes, polygonal tubs, ovoid tubes, etc.). In other examples, some or all of the top rail 310, the aft member 311, the circumferential member 312, and the arms 314A, 314B, 314C, 314D, 314E, 314F, 314G, 314H, 314I, 314J are solid members (e.g., members with solid cross-sections, etc.) and/or are flat plate. In some examples, the top rail 310, the aft member 311, the circumferential member 312, and/or the arms 314A, 314B, 314C, 314D, 314E, 314F, 314G, 314H, 314I, 314J can include (e.g., be composed of, etc.) of a metal, such as steel (e.g., stainless steel, high-strength low-alloy (HSLA) steel, etc.). aluminum (e.g., aluminum 2024, aluminum 7075, etc.), a titanium alloy, and/or a nickel alloy. Additionally or alternatively, the top rail 310, the aft member 311, the circumferential member 312, and the arms 314A, 314B, 314C, 314D, 314E, 314F, 314G, 314H, 314I, 314J can be composed of other materials, such as a high strength composite.

The length of the top rail 310, the aft member 311, the circumferential member 312, and/or the arms 314A, 314B, 314C, 314D, 314E, 314F, 314G, 314H, 314I, 314J and/or the location of the couplings can configured based on the desired strength, stiffness, manufacturability, maintainability, while flutter control and core closure control requirements associated with the gas turbine engine 300. Similarly, the spacing between the top rail 310 and the outer diameter of the gas turbine engine 300 (e.g., the height of the first spatial pylon 302, etc.) can be configured based on the stiffness, access (e.g., access to the internal components of the gas turbine engine 300, etc.), performance, and/or other factors of the gas turbine engine 300.

The couplings between the top rail 310, the aft member 311, the circumferential member 312, and the arms 314A, 314B, 314C, 314D (e.g., the coupling between the circumferential member 312 and the top rail 310, the coupling between the circumferential member 312 and the first arm 314A, the coupling between the top rail 310 and the aft member 311, the coupling between the third arm 314C and the aft member 311, etc.) can be implemented by one or more welds, one or more threaded connections, one or more external connections (e.g., bolts, rivets, other fasteners, etc.), etc. Additionally or alternatively, some or all of the top rail 310, the aft member 311, the circumferential member 312, and the arms 314A, 314B, 314C, 314D are integral components (e.g., formed via forging, formed via additive manufacturing, formed via negative manufacturing, etc.).

In the illustrated example of FIG. 3A, the top rail 310 of the first spatial pylon 302 extends axially along the length of the gas turbine engine 300 between the front mount 304 and the aft member 311. In the illustrated example of FIG. 3A, the front mount 304 is coupled directly to the top rail 310. In other examples, the front mount 304 can be coupled to the top rail 310 via another intermediate member (e.g., an arm similar to the arms 314A, 314B, 314C, 314D, 314E, 314F, 314G, 314H, 314I, 314J, etc.). In the illustrated example of FIG. 3A, the circumferential member 312 and the arms 314A, 314B, 314C, 314D, 314E, 314F, 314G, 314H, 314I, 314J are coupled to the midspan of the top rail 310 between the front mount 304 and the aft mount 308 (e.g., aft member 311, etc.). In some examples, the top rail 310 can be coupled (e.g., via one or more linkages, via one or more fasteners, via one or more welds, via one or more interference fits, etc.) directly to a wing of a gas turbine engine 300.

The aft member 311 extends vertically from the aft mount 308. In the illustrated example of FIG. 3A, the mid-span of the aft member 311 is coupled to the top rail 310 and the fifth arm 314E. In other examples, the fifth arm 314E is not coupled to the aft member 311. In some such examples, the fifth arm 314E is coupled to the top rail 310. In some examples, the aft member 311 extends into the wing of an aircraft. In other examples, the aft member 311 is coupled to a wing of an aircraft. In other examples, the aft member 311 is not directly coupled to an aircraft. In some examples, the aft member 311 is absent. In some such examples, the aft member 311 is coupled directly to the top rail 310.

The circumferential member 312 extends circumferentially around the gas turbine engine 300 between the first middle mount 306A and the second middle mount 306B. In the illustrated example of FIG. 3B, the curvature of the circumferential member 312 defines an arc with a center point that is concentric with a centerline of the gas turbine engine 300. In other examples, the circumferential member 312 can have any other suitable curvature. In some examples, the length of the circumferential member 312 is based on the location of the mounts 306A, 306B.

The first arm 314A and the second arm 314B are members that are generally axially disposed between the front frame portion 316 and the middle frame portion 318. The first arm 314A extends between the top rail 310 and the second middle mount 306B. The second arm 314B extends between the top rail 310 and the second middle mount 306B. In the illustrated example of FIG. 3A, the ends of the arms 314A, 314B coupled to the top rail 310 are adjacent to the front mount 304. In the illustrated example of FIGS. 3A and 3B, the first arm 314A and the second arm 314B are straight (e.g., the first arm 314A and the second arm 314B have linear centerline axes, etc.). In other examples, the first arm 314A and the second arm 314B are curved. In some examples, the first arm 314A and/or the second arm 314B are absent.

The third arm 314C and the fourth arm 314D are members that are generally axially disposed between the front frame portion 316 and the middle frame portion 318. The third arm 314C and the fourth arm 314D structurally support (e.g., stiffen, reinforce, etc.) the first arm 314A and the second arm 314B, respectively. In the illustrated example of FIG. 3A, the third arm 314C extends between a middle point of the first arm 314A and the top rail 310. In the illustrated example of FIG. 3A, the fourth arm 314D extends between a middle point of the second arm 314B and the top rail 310. In the illustrated example of FIG. 3A, the third arm 314C and the fourth arm 314D are straight. In other examples, the third arm 314C and the fourth arm 314D are curved. In some examples, the third arm 314C and the fourth arm 314D are absent.

The fifth arm 314E and the sixth arm 314F are structural members that are generally disposed between the middle frame portion 318 and the aft frame portion 320. That is, the fifth arm 314E and the sixth arm 314F are generally aligned with the carcass 322. In the illustrated example of FIG. 3A, the fifth arm 314E extends between the second middle mount 306B and the aft member 311. In the illustrated example of FIG. 3A, the sixth arm 314F extends between the second middle mount 306B and the aft member 311. In the illustrated example of FIG. 3A, the fifth arm 314E and the sixth arm 314F are straight. In other examples, the fifth arm 314E and the sixth arm 314F are curved. The fifth arm 314E and the sixth arm 314F transfer thrust loads generated by the gas turbine engine 300 to the aft member 311. The fifth arm 314E and the sixth arm 314F are also referred to herein as “thrust arms” or “thrust members.” In some examples, the transferring of thrust loads via the fifth arm 314E enables the gas turbine engine 300 to lack a thrust linkage.

The seventh arm 314G, the eighth arm 314H, the ninth arm 314I, and the tenth arm 314J are members that are disposed between the middle frame portion 318 and the aft frame portion 320 (e.g., the arms 314G, 314H, 314I, 314J) and are axially aligned with the carcass 322. The seventh arm 314G and the ninth arm 314I structurally support (e.g., stiffen, reinforce, etc.) the fifth arm 314E. The eighth arm 314H and the tenth arm 314J structurally support (e.g., stiffen, reinforce, etc.) the sixth arm 314F. In the illustrated example of FIG. 3A, the seventh arm 314G extends between the top rail 310 adjacent to the circumferential member 312 and a mid-span location of the fifth arm 314E. In the illustrated example of FIG. 3A, the eighth arm 314H extends between the top rail 310 adjacent to the circumferential member 312 and a mid-span location of the sixth arm 314F. In the illustrated example of FIG. 3A, the ninth arm 314I radially extends between the top rail 310 and a mid-span location of the fifth arm 314E. In the illustrated example of FIG. 3A, the tenth arm 314J radially extends between the top rail 310 and a mid-span location of the sixth arm 314F. In the illustrated example of FIG. 3A, the arms 314G, 314H, 314I, 314J are straight. In other examples, the arms 314G, 314H, 314I, 314J are curved. In some examples, some or all of the arms 314G, 314H, 314I, 314J are absent.

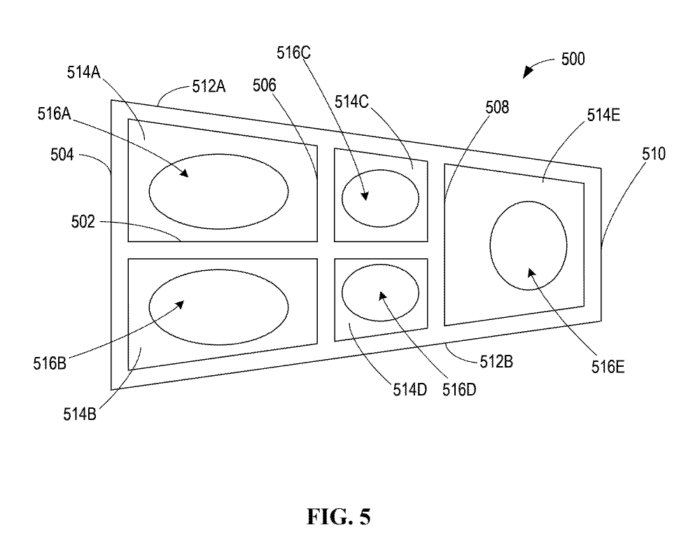

The topology of the first spatial pylon 302 (e.g., the geometric relationships between top rail 310, the aft member 311, the circumferential member 312, and the arms 314A, 314B, 314C, 314D, etc.) and the sizing of the top rail 310, the aft member 311, the circumferential member 312, and the arms 314A, 314B, 314C, 314D can be configured (e.g., designed, etc.) to have a comparatively lower weight (e.g., higher fuel efficiency, etc.) than prior box pylons, while maintaining the design requirements of the gas turbine engine (e.g., strength requirements, life/durability requirements, performance requirements, manufacturability requirements, maintainability requirements, etc.). In some examples, some or all of the top rail 310, the aft member 311, the circumferential member 312, and the arms 314A, 314B, 314C, 314D can include membranes (e.g., metal membranes, etc.) that extend therebetween. An example pylon with a plurality of membranes is described below in conjunction with FIG. 5.

FIG. 3B is a schematic side view of the gas turbine engine 300 and the first example spatial pylon 302 of FIG. 3A mounted to a wing 338 in a first configuration. As shown in the example of FIG. 3B, the spatial pylon 302 is mounted with respect to an upper surface of the wing 338. The spatial pylon 302 configuration of FIG. 3B attaches to the engine 300 (e.g., the unducted fan propulsor 38) via mountings 304, 306A, and 306B. However, as shown in the example of FIG. 3B, the aft or rear frame 320 is not connected with an additional mount to the pylon 302 or wing 338 but is instead supported by the carcass 322 and its connections to the mounted front frame portion 316 and middle frame portion 318.

FIG. 3C is a schematic side view of the gas turbine engine 300 and the first example spatial pylon 302 of FIG. 3A mounted to a wing 338 in a second configuration. As shown in the example of FIG. 3C, the spatial pylon 302 is mounted with respect to a lower surface of the wing 338. The spatial pylon 302 configuration of FIG. 3C attaches to the engine 300 (e.g., the unducted fan propulsor 38) via mountings 304, 306A, and 306B. However, as shown in the example of FIG. 3C, the aft or rear frame 320 is not connected with an additional mount to the pylon 302 or wing 338 but is instead supported by the carcass 322 and its connections to the mounted front frame portion 316 and middle frame portion 318.

FIG. 3D is an example illustration of the gas turbine engine 300 in an unducted configuration (e.g., the unducted fan propulsor 38) mounted to the wing 338 using the spatial pylon 302. As shown in the example view of FIG. 3D, the spatial pylon 302 mounts to the engine 300 at the middle frame 318.

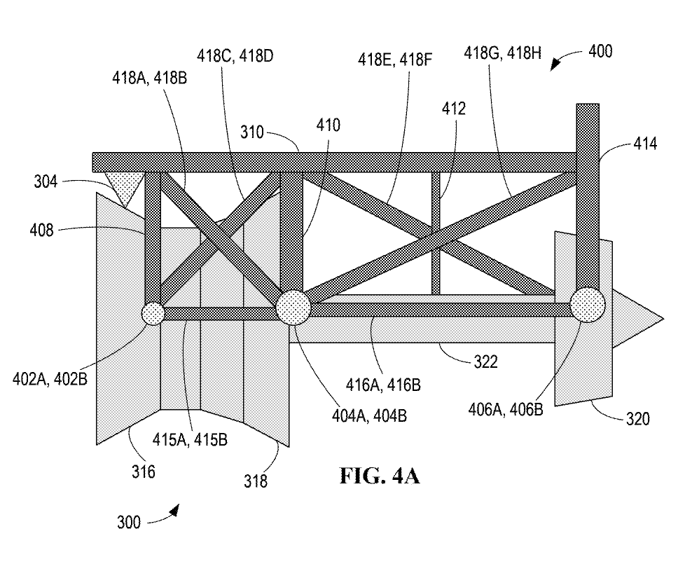

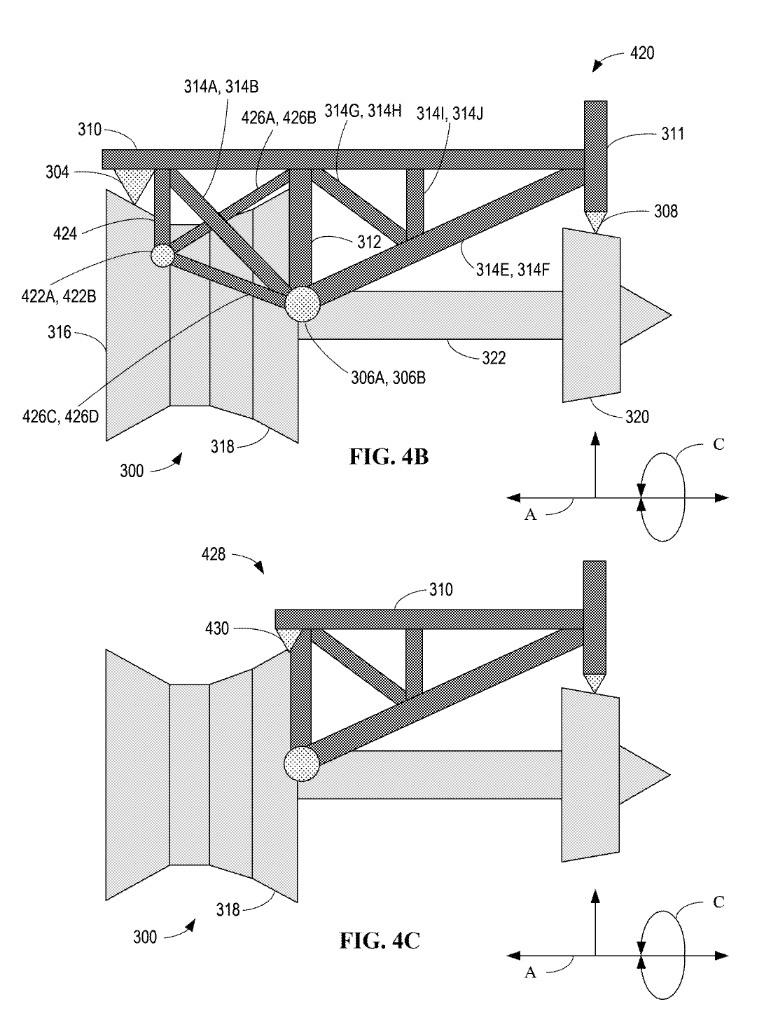

FIG. 4A is a schematic side view of the gas turbine engine 300 of FIG. 3A and an example second spatial pylon 400 implemented in accordance with teachings of this disclosure. In the illustrated example of FIG. 4A, the second spatial pylon 400 includes the front mount 304 of FIG. 3A, a first middle mount 402A, a second middle mount 402B, a third middle mount 404A, a fourth middle mount 404B, a first aft mount 406A, and a second aft mount 406B. The second spatial pylon 400 includes the top rail 310 of FIGS. 3A and 3B, a first circumferential member 408, a second circumferential member 410, and a third circumferential member 412, a first axial arm 415A, a second axial arm 415B, a third axial arm 416A, a fourth axial arm 416B, a first cross arm 418A, a second cross arm 418B, a third cross arm 418C, a fourth cross arm 418E, a fifth cross arm 418F, a sixth cross arm 418F, a seventh cross arm 418G, and an eighth cross arm 418H. The second spatial pylon 400 and the structural members thereof are similar to the first spatial pylon 302 of FIGS. 3A and 3B and the structural members thereof, except as noted otherwise.

The mounts 402A, 402B are similar to the mounts 306A, 306B of FIGS. 3A and 3B, except the mounts 402A, 402B are coupled to the front frame portion 316. The mounts 404A, 404B are similar to the mounts 306A, 306B of FIGS. 3A and 3B. The mounts 406A, 406B are similar to the mounts 306A, 306B of FIGS. 3A and 3B, except that the mounts 406A, 406B are coupled to the aft frame portion 320. In the illustrated example of FIG. 4A, the mounts 402A, 402B, 404A, 404B, 406A, 406B are radially aligned. That is, in the illustrated example of FIG. 4A, the first middle mount 402A, the third middle mount 404A, and the first aft mount 406A are disposed at the 3 o’clock position and the second middle mount 402B, the fourth middle mount 404B, and the second aft mount 406B are disposed at the 9 o’clock position. In other examples, some or all of the mounts 402A, 402B, 404A, 404B, 406A, 406B can have different radial position(s).

The circumferential members 408, 410, 412, 414 are similar to the circumferential member 312 of FIGS. 3A and 3B, except as noted otherwise. In the illustrated example of FIG. 4A, the first circumferential member 408 extends between the mounts 402A, 402B, and is coupled to the top rail 310. In the illustrated example of FIG. 4A, the second circumferential member 410 extends between the mounts 404A, 404B, and is coupled to the top rail 310. In the illustrated example of FIG. 4A, the third circumferential member 412 extends between mid-span locations of the third axial arm 416A and the fourth axial arm 416B and is coupled to the top rail 310. In the illustrated example of FIG. 4A, the fourth circumferential member 414 extends between the mounts 406A, 406B, and is coupled to the top rail 310. In the illustrated example of FIG. 4A, the circumferential members 408, 410, 414 extend partially around the gas turbine engine 300. In the illustrated example of FIG. 4A, the circumferential members 408, 410, 412, 414 have the same length due to the positioning of the mounts 402A, 402B, 404A, 404B, 406A, 406B. In other examples, some or all of the circumferential members 408, 410, 412, 414 have different lengths.

In the illustrated example of FIG. 4A, the first middle mount 402A and the second middle mount 402B have a same displacement from the main rail 310 and at a same relative height on the gas turbine engine 300. That is, the first middle mount 402A, and the second middle mount 402B have a same vertical displacement from the main rail 310 and a same angular displacement from the main rail 310 (e.g., the first middle mount 402A and the second middle mount 402B are both displaced from the main rail 310 by 90 degrees, etc.). In the illustrated example of FIG. 4A, the third middle mount 404A and the fourth middle mount 404B have a same displacement from the main rail 310 and at a same relative height on the gas turbine engine 300. Similarly, the first aft mount 406A and the second middle mount 406B have a same displacement from the main rail 310 and at a same relative height on the gas turbine engine 300.

The axial arms 415A, 415B extend axially and are generally disposed between the front frame portion 316 and the middle frame portion 318. In the illustrated example of FIG. 4A, the first axial arm 415A extends between the first middle mount 402A and the third middle mount 404A. In the illustrated example of FIG. 4A, the second axial arm 415B extends between the second middle mount 402B and the fourth middle mount 404B. The axial arms 415A, 415B increase the axial stiffness of the second spatial pylon 400 between the front frame portion 316 and the aft frame portion 320 and react axial loads between the mounts 402A, 402B, 404A, 404B. The axial arms 416A, 416B extend axially and are generally disposed between the middle frame portion 318 and the aft frame portion 320 (e.g., the axial arms 416A, 416B are aligned with the carcass 322, etc.). The third axial arm 416A extends between the third middle mount 404A and the first aft mount 406A. The fourth axial arm 416B extends between the fourth middle mount 404B and the second aft mount 406B. The axial arms 416A, 416B increase the axial stiffness of the second spatial pylon 400 between the middle frame portion 318 and the aft frame portion 320, and react axial loads between the mounts 404A, 404B, 406A, 406B.

In the illustrated example of FIG. 4A, the axial arms 415A, 415B, 416A, 416B are generally radially aligned with the centerline of the gas turbine engine 300. In other examples, one or both of the axial arms 415A, 415B, 416A, 416B are radially displaced from the centerline of the gas turbine engine 300. In the illustrated example of FIG. 4A, the axial arms 415A, 415B, 416A, 416B are straight (e.g., the axial arms 415A, 415B, 416A, 416B are linear centerline axes, etc.). In other examples, some or all of the axial arms 415A, 415B, 416A, 416B are curved. In some examples, some or all of the axial arms 415A, 415B, 416A, 416B are absent.

The cross arms 418A, 418B, 418C, 418D, 418E, 418F, 418G, 418H reinforce the second spatial pylon 400. In the illustrated example of FIG. 4A, the first cross arm 418A, the second cross arm 418B, the third cross arm 418C, and the fourth cross arm 418D are disposed axially between the front frame portion 316 and the middle frame portion 318. In the illustrated example of FIG. 4A, the first cross arm 418A, the second cross arm 418B, the third cross arm 418C, and the fourth cross arm 418D are disposed axially between the first circumferential member 408 and the second circumferential member 410. In the illustrated example of FIG. 4A, the first cross arm 418A extends between the first middle mount 402A and a location of the top rail 310 adjacent to the front mount 304. In the illustrated example of FIG. 4A, the second cross arm 418B extends between the second middle mount 402B and a location of the top rail 310 adjacent to the front mount 304. In the illustrated example of FIG. 4A, the third cross arm 418C extends between the third middle mount 404A and a mid-span location of the top rail 310 adjacent to the second circumferential member 410. In the illustrated example of FIG. 4A, the fourth cross arm 418D extends between the fourth middle mount 404B and a mid-span location of the top rail 310 adjacent to the second circumferential member 410.

In the illustrated example of FIG. 4A, the fifth cross arm 418E, the sixth cross arm 418F, the seventh cross arm 418G, and the eighth cross arm 418H are disposed axially between the middle frame portion 318 and the aft frame portion 320. In the illustrated example of FIG. 4A, the fifth cross arm 418E extends between a mid-span location of the top rail 310 adjacent to the second circumferential member 410 and the first aft mount 406A. In the illustrated example of FIG. 4A, the sixth cross arm 418F extends between a mid-span location of the top rail 310 adjacent to the second circumferential member 410 and the second aft mount 406B. In the illustrated example of FIG. 4A, the seventh cross arm 418G extends between the third middle mount 404A and a location on the top rail adjacent to the fourth circumferential member 414. In the illustrated example of FIG. 4A, the eighth cross arm 418H extends between the fourth middle mount 404B and a location on the top rail adjacent to the fourth circumferential member 414. In the illustrated example of FIG. 4A, the cross arms 418A, 418B, 418C, 418D, 418E, 418F, 418G, 418H are straight (e.g., the cross arms 418A, 418B, 418C, 418D, 418E, 418F, 418G, 418H are linear centerline axes, etc.). In other examples, some or all of the cross arms 418A, 418B, 418C, 418D, 418E, 418F, 418G, 418H are curved. In some examples, some or all of the cross arms 418A, 418B, 418C, 418D, 418E, 418F, 418G, 418H are absent.

FIG. 4B is a schematic side view of the gas turbine engine 300 and an example third spatial pylon 420 implemented in accordance with teachings of this disclosure. In the illustrated example of FIG. 4B, the third spatial pylon 420 includes the front mount 304 of FIG. 3A, the aft mount 308 of FIG. 3A, the middle mounts 306A, 306B of FIG. 3A. In the illustrated example of FIG. 4B, the third spatial pylon 420 includes the top rail 310 of FIGS. 3A and 3B, the aft member 311 of FIG. 3A, the circumferential member 312 of FIG. 3A, and the arms 314A, 314B, 314E, 314F, 314G, 314H, 314I, 314J of FIG. 3A. The third spatial pylon 420 is similar to the first spatial pylon 302 of FIGS. 3A and 3B, except as noted otherwise. Particularly, the third spatial pylon 420 includes a third middle mount 422A, and a fourth middle mount 422B, a second circumferential member 424, a first cross arm 426A, a second cross arm 426B, a third cross arm 426C, and a fourth cross arm 426D.

The mounts 422A, 422B are similar to the mounts 306A, 306B of FIGS. 3A and 3B, except the mounts 402A, 402B are coupled to the front frame portion 316. In the illustrated example of FIG. 4B, the mounts 422A, 422B are radially displaced from that the mounts 306A, 306B toward the top rail 310. In the illustrated example of FIG. 4B, the middle mounts 422A, 422B is disposed at a 2 o’clock and a 10 o’clock position. In other examples, the middle mounts 422A, 422B can be disposed at any other location on the gas turbine engine 300. In some examples, one or both of the middle mounts 422A, 422B are absent. The second circumferential member 424 is similar to the circumferential member 312 of FIGS. 3A and 3B, except as noted otherwise. In the illustrated example of FIG. 4B, the second circumferential member 424 extends between the third middle mount 422A and the fourth middle mount 422B and is coupled to the top rail 310. In the illustrated example of FIG. 4B, the second circumferential member 424 is shorter than the circumferential member 312 due to the position of the middle mounts 422A, 422B. In other examples, the second circumferential member 424 can have other lengths depending on the position of the middle mounts 422A, 422B.

In the illustrated example of FIG. 4B, the first middle mount 402A and the second middle mount 402B have a same displacement from the main rail 310 and at a same relative height on the gas turbine engine 300. In the illustrated example of FIG. 4B, the first middle mount 306A and the second middle mount 306B have a same displacement from the main rail 310 and at a same relative height on the gas turbine engine 300.

The cross arms 426A, 426B, 426C, 426D are similar to the cross arms 418A, 418B, 418C, 418D, 418E, 418F, 418G, 418H of FIG. 4A, except as noted otherwise. In the illustrated example of FIG. 4B, the first cross arm 426A extends between a location of the top rail 310 adjacent to the front mount 304 and the first middle mount 306A. In the illustrated example of FIG. 4B, the second cross arm 426B extends between a location of the top rail 310 adjacent to the front mount 304 and the second middle mount 306B. In the illustrated example of FIG. 4B, the third cross arm 426C extends between a mid-span location of the top rail 310 adjacent to the circumferential member 312 and the third middle mount 422A. In the illustrated example of FIG. 4B, the fourth cross arm 426D extends between a mid-span location of the top rail 310 adjacent to the circumferential member 312 and the fourth middle mount 422B. In the illustrated example of FIG. 4B, the cross arms 426A, 426B, 426C, 426D are straight (e.g., the cross arms 426A, 426B, 426C, 426D are linear centerline axes, etc.). In other examples, some or all of the cross arms 426A, 426B, 426C, 426D are curved. In some examples, some or all of the cross arms 426A, 426B, 426C, 426D are absent.

FIG. 4C is a schematic side view of the gas turbine engine 300 of FIG. 3A and an example fourth spatial pylon 428 implemented in accordance with teachings of this disclosure. The fourth spatial pylon 428 is similar to the first spatial pylon 302 of FIG. 3A, except that the fourth spatial pylon 428 does not include members upstream of the middle frame portion 318 and/or the circumferential member 312 of FIGS. 3A and 3B. That is, the fourth spatial pylon 428 does not include the arms 314A, 314B, 314C, 314D of FIG. 3A and the top rail 310 extends between the middle frame portion 318 and the aft frame portion 320 (e.g., the top rail 310 does not extend axially beyond the middle frame portion 318, etc.). In the illustrated example of FIG. 4C, the fourth spatial pylon 428 includes a front mount 430. The fourth mount 430 is similar to the front mount 304 of FIG. 3A, except that the fourth mount 430 is coupled to the middle frame portion 318. Because the fourth spatial pylon 428 does not include features axially forward of the middle frame portion 318, the fourth spatial pylon is suitable for use with gas turbine engines with external blades, such as turboprop gas turbine engines and open-fan gas turbine engines.

FIG. 5 is an example top view of an example fifth spatial pylon 500 implemented in accordance with teachings of this disclosure. In the illustrated example of FIG. 5, the fifth spatial pylon 500 includes a top rail 502, a first circumferential member 504, a second circumferential member 506, a third circumferential member 508, a fourth circumferential member 510, a first axial arm 512A, and a second axial arm 512B. In the illustrated example of FIG. 5, the fifth spatial pylon 500 includes a first membrane 514A, a second membrane 514B, a third membrane 514C, a fourth membrane 514D, and a fifth membrane 514E. In the illustrated example of FIG. 5, the membranes 514A, 514B, 514C, 514D, 514E include a first opening 516A, a second opening 516B, a third opening 516C, a fourth opening 516D, and a fifth opening 516E.

The fifth spatial pylon 500 can be used to couple a gas turbine engine (e.g., the gas turbine engine 300 of FIG. 3A, etc.) to an aircraft. The top rail 502 is similar to the top rail 310 of FIG. 3A, except that the top rail 502 does not extend the full axial length of the fifth spatial pylon 500. The circumferential members 504, 506, 508, 510 are similar to the circumferential members 408, 410, 412, 414 of FIG. 4A, respectively. The axial arms 512A, 512B are similar to the axial arms 416A, 416B of FIG. 4B. In some examples, the top rail 502 and/or one or more of the circumferential members 504, 506, 508, 510 can include one or more mounts similar to one or more of the mounts 304, 306A, 306B, 308 of FIG. 3A.

The membranes 514A, 514B, 514C, 514D, 514E are rigid plates disposed between the structural members of the fifth spatial pylon 500. The membranes 514A, 514B, 514C, 514D, 514E increase the stiffness of the fifth spatial pylon 500. In some examples, the membranes 514A, 514B, 514C, 514D, 514E are plates (e.g., forged plates, etc.) that are coupled to the structural members of the fifth spatial pylon 500. In other examples, the membranes 514A, 514B, 514C, 514D, 514E are a flexible mesh structure. In some examples, the membranes 514A, 514B, 514C, 514D, 514E are coupled to the structural members of the fifth spatial pylon 500 via one or more welds. In other examples, the membranes 514A, 514B, 514C, 514D, 514E are integral (e.g., unitary, monolithic, etc.) with some or all of the structural members of the fifth spatial pylon 500. In some examples, the membranes 514A, 514B, 514C, 514D, 514E include (e.g., contain, are composed of, etc.) the same material as the structural members of the fifth spatial pylon 500. In other examples, the membranes 514A, 514B, 514C, 514D, 514E include (e.g., contain, are composed of, etc.) a different type of material (e.g., steel, aluminum, titanium, a composite, a nickel alloy, etc.) than the structural members of the fifth spatial pylon 500.

In the illustrated example of FIG. 5, the first membrane 514A is disposed between the top rail 502, the first circumferential member 504, the second circumferential member 506, and the first axial arm 512A. In the illustrated example of FIG. 5, the second membrane 514B is disposed between the top rail 502, the first circumferential member 504, the second circumferential member 506, and the second axial arm 512B. In the illustrated example of FIG. 5, the third membrane 514C is disposed between the top rail 502, the second circumferential member 506, the third circumferential member 508, and the first axial arm 512A. In the illustrated example of FIG. 5, the fourth membrane 514D is disposed between the top rail 502, the second circumferential member 506, the third circumferential member 508, and the second axial arm 512B. In the illustrated example of FIG. 5, the fifth membrane 514E is disposed between the second circumferential member 506, the third circumferential member 508, and the axial arms 512A, 512B.

The openings 516A, 516B, 516C, 516D, 516E are disposed in the membranes 514A, 514B, 514C, 514D, 514E, respectively. The openings 516A, 516B, 516C, 516D, 516E reduce the weight of the membranes 514A, 514B, 514C, 514D. In the illustrated example of FIG. 5, the openings 516A, 516B, 516C, 516D, 516E are oval-shaped (e.g., elliptically shaped, etc.). In other examples, the openings 516A, 516B, 516C, 516D, 516E can have any other suitable shape (e.g., circular, polygonal, etc.). In the illustrated example of FIG. 5, each of the membranes 514A, 514B, 514C, 514D, 514E includes a single opening (e.g., the openings 516A, 516B, 516C, 516D, 516E, etc.). In other examples, some or all of the membranes 514A, 514B, 514C, 514D, 514E can include additional openings (e.g., two openings, three openings, etc.).

While one example configuration of the fifth spatial pylon 500 is depicted in FIG. 5, it should be appreciated that the fifth spatial pylon 500 can have different spatial configurations. That is, the membranes 514A, 514B, 514C, 514D, 514E (e.g., including the openings 516A, 516B, 516C, 516D, 516E, including a different configuration of openings, not including the openings, etc.) can be used with any other spatial pylon configuration (e.g., the first spatial pylon 302 of FIGS. 3A and 3B, the second spatial pylon 400 of FIG. 4A, the third spatial pylon 420 of FIG. 4B, the fourth spatial pylon 428 of FIG. 4C, etc.).

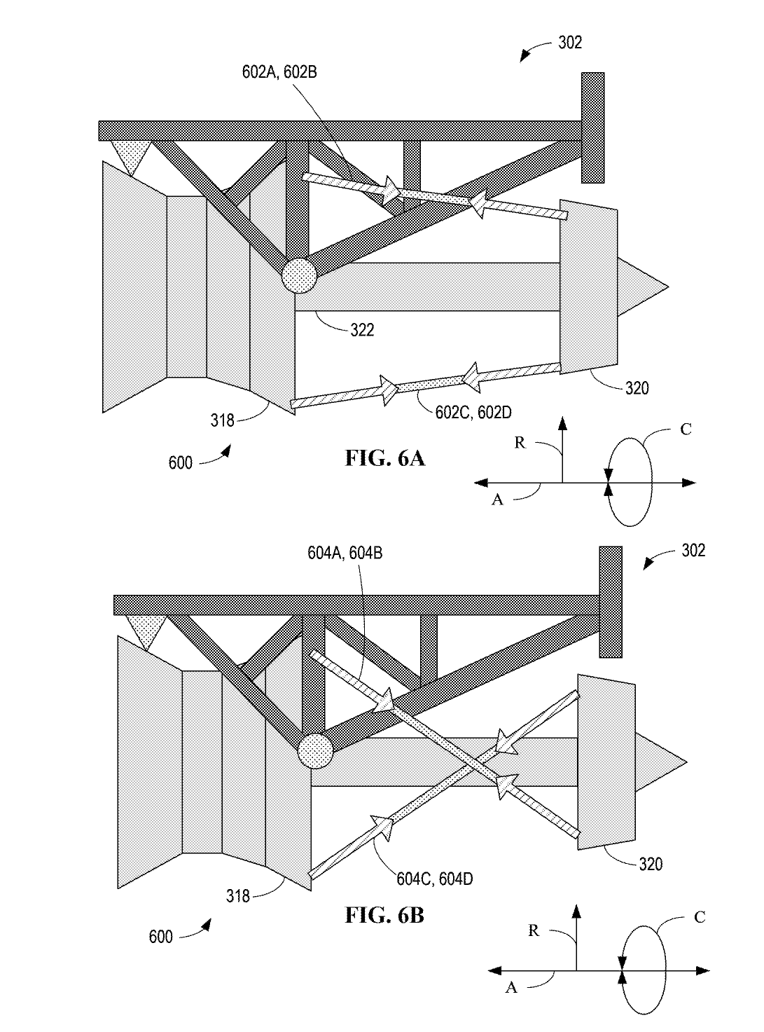

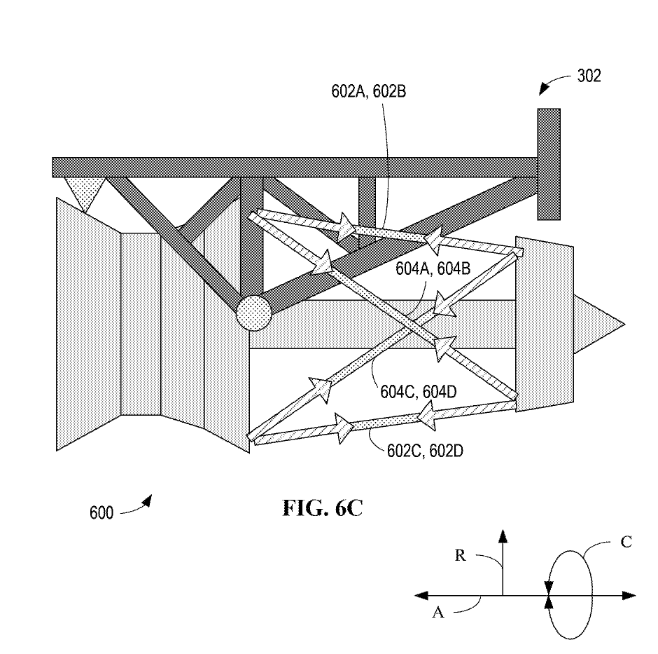

FIG. 6A is a schematic side view of a gas turbine engine 600 and the first spatial pylon 302 of FIG. 3A including a first longitudinal harness 602A, a second longitudinal harness 602B, a third longitudinal harness 602C, and a fourth longitudinal harness 602D, implemented in accordance with teachings of this disclosure. In the illustrated example of FIG. 6A, the gas turbine engine 600 includes the middle frame portion 318 of FIG. 3A and the aft frame portion 320 of FIG. 3A. The gas turbine engine 600 is similar to the gas turbine engine 300 of FIG. 3A, except the gas turbine engine 600 is cantilevered (e.g., the aft frame portion 320 of the gas turbine engine 600 is not coupled to the first spatial pylon 302, etc.).

The longitudinal harnesses 602A, 602B, 602C, 602D are flexible members that react tensional loads therebetween (e.g., the longitudinal harnesses 602A, 602B, 602C, 602D do not react compression loads, etc.). In some examples, the longitudinal harnesses 602A, 602B, 602C, 602D can be implemented by metal cables (e.g., steel cables, titanium cables, aluminum cables, etc.). In other examples, the longitudinal harnesses 602A, 602B, 602C, 602D can be implemented by another type of cable, strap, and/or flexible member. In some examples, the longitudinal harnesses 602A, 602B, 602C, 602D are prestressed to increase resistance to tensional loads.

In the illustrated example of FIG. 6A, the longitudinal harnesses 602A, 602B, 602C, 602D extend between the middle frame portion 318 and the aft frame portion 320. Particularly, the first longitudinal harness 602A and the second longitudinal harness 602B are generally disposed adjacent to a 12 o’clock position on the gas turbine engine 300 (e.g., the longitudinal harnesses 602A, 602B is a top-to-top connection, the longitudinal harnesses 602A, 602B are radially adjacent to the top rail 310 of the first spatial pylon 302, etc.). In the illustrated example of FIG. 6A, the third longitudinal harness 602C and the fourth longitudinal harness 602D are generally disposed adjacent to a 6 o’clock position on the gas turbine engine 300 (e.g., the longitudinal harnesses 602C, 602D are bottom-to-bottom connections, the longitudinal harnesses 602C, 602D are radially distal to the top rail 310 of the first spatial pylon 302, etc.). The longitudinal harnesses 602A, 602B, 602C, 602D increase the stiffness of the gas turbine engine 300 against rotation of the carcass 322, which increases the stiffness of the gas turbine engine 300 when subjected to 1P loading (e.g., propeller loading, etc.) and other maneuver loads.

FIG. 6B is a schematic side view of the gas turbine engine 600 of FIG. 6A and the first spatial pylon 302 of FIG. 3A including a first diagonal harness 604A, a second diagonal harness 604B, a third diagonal harness 604C, and a fourth diagonal harness 604D implemented in accordance with teachings of this disclosure.

The diagonal harnesses 604A, 604B, 604C, 604D are similar to the longitudinal harnesses 602A, 602B, 602C, 602D of FIG. 6A, except as noted otherwise. In the illustrated example of FIG. 6B, the diagonal harnesses 604A, 604B, 604C, 604D extend between the middle frame portion 318 and the aft frame portion 320. Particularly, in the illustrated example of FIG. 6B, the first diagonal harness 604A and the second diagonal harness 604B have first ends disposed adjacent to a 12 o’clock position on the gas turbine engine 600 adjacent to the middle frame portion 318 and second ends adjacent to a 6 o’clock position on the gas turbine engine 600 adjacent to the aft frame portion 320 (e.g., the diagonal harness 604A, 604B is top-to-bottom connections, etc.). In the illustrated example of FIG. 6B, the third diagonal harness 604C and the fourth diagonal harness 604D have first ends adjacent to a 6 o’clock position on the gas turbine engine 600 adjacent to the middle frame portion 318 and second ends disposed adjacent to a 12 o’clock position on the gas turbine engine 600 adjacent to the aft frame portion 320 (e.g., the diagonal harnesses 604C, 604D are bottom-to-top connections, etc.). The diagonal harnesses 604A, 604B, 604C, 604D increase the stiffness of the gas turbine engine 300 against vertical loads, which increases the resistance of the gas turbine engine 300 when subjected to 1G loading (e.g., gravitational loading, etc.).

FIG. 6C is a schematic side view of the gas turbine engine 600 and the first spatial pylon 302 of FIG. 3A. In the illustrated example of FIG. 6C, the gas turbine engine 600 includes the longitudinal harnesses 602A, 602B, 602C, 602D of FIG. 6A and the diagonal harnesses 604A, 604B, 604C, 604D of FIG. 6B. The longitudinal harness 602A, 602B, 602C, 602D increase the resistance of the gas turbine engine 600 to aerodynamic loads and the diagonal harnesses 604A, 604B, 604C, 604D increase the resistance of the gas turbine engine 600 to gravitational loads.

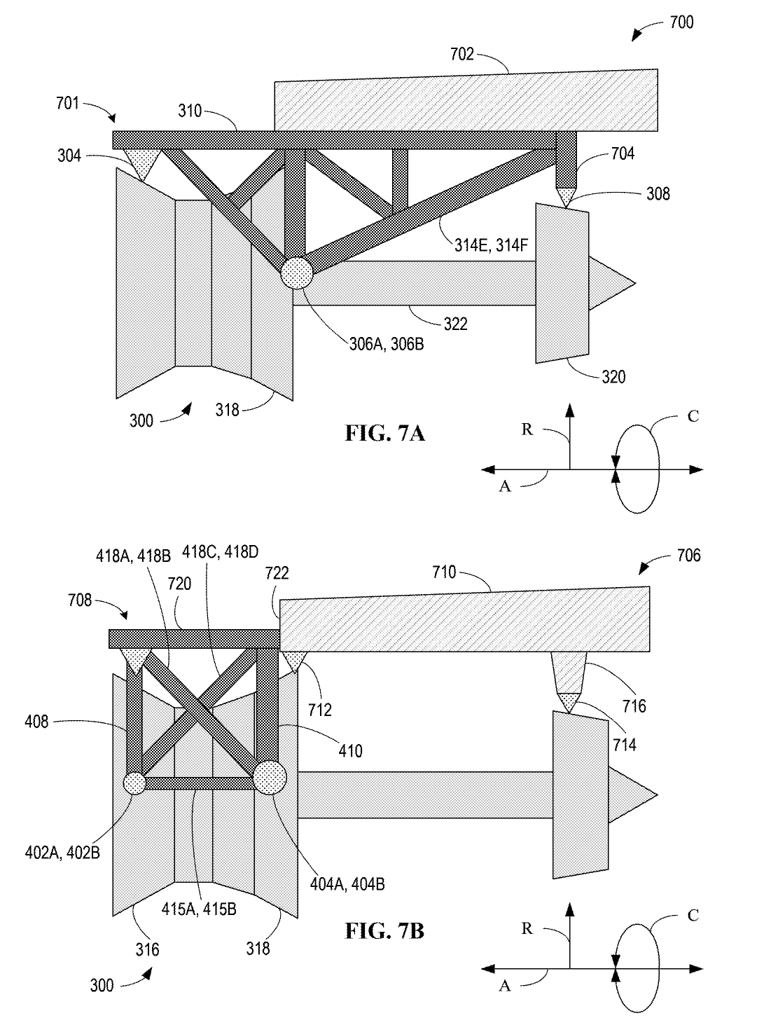

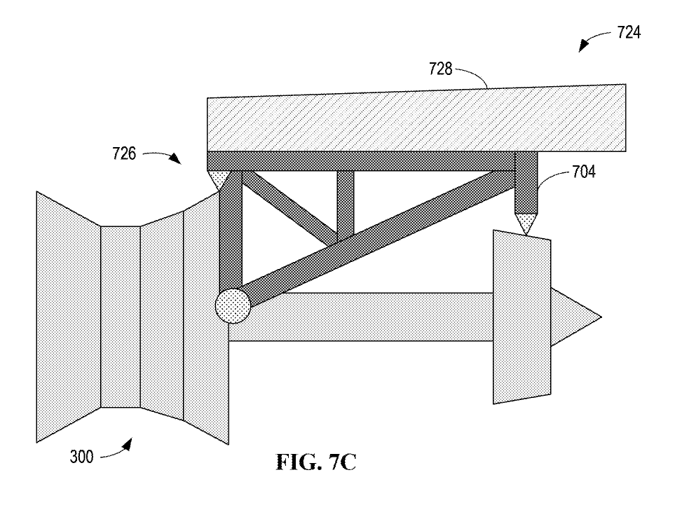

FIG. 7A is a schematic side view of the gas turbine engine 300 of FIG. 3A and an example first combined pylon 700 implemented in accordance with teachings of this disclosure. In the illustrated example of FIG. 7A, the first combined pylon 700 includes a spatial pylon 701 and a partial box pylon 702. The spatial pylon 701 is similar to the first spatial pylon 302 of FIGS. 3A and 3B, except that the spatial pylon 701 includes an aft member 704 and as otherwise noted. In the illustrated example of FIG. 7A, the spatial pylon 701 includes the top rail 310 of FIGS. 3A and 3B, and the cross arms 314E, 314F of FIG. 7A.

Like the first spatial pylon 302 of FIGS. 3A and 3B, the spatial pylon 701 is a multi-mount structure (e.g., the spatial pylon 701 includes the mounts 304, 306A, 306B, 308 of FIG. 3A, etc.) that fully constrain the boundary conditions of the gas turbine engine (e.g., the spatial pylon 701 transfers yaw, pitch, and roll loads and moments between the gas turbine engine 300 and the partial box pylon 702, etc.). The aft member 704 is similar to the aft member 311 of FIG. 3A, excepted as noted otherwise. In the illustrated example, the aft member 704 extends between the aft mount 308 and the partial box pylon 702. In some examples, the aft member 704 is coupled to the partial box pylon 702 via one or more welds, via one or more fasteners, and/or via one or more threaded connections. Additionally or alternatively, the aft member 704 extends through the partial box pylon 702 and is coupled to the aircraft (e.g., the wing of an aircraft, the body of an aircraft, the tail of an aircraft, etc.).

The partial box pylon 702 is a rigid shell that transfers load between the spatial pylon 701 and an aircraft. In the illustrated example of FIG. 7A, the partial box pylon 702 is partially integrated with the spatial pylon 701 (e.g., the partial box pylon 702 is shorter than spatial pylon 701, etc.). The integration of the partial box pylon 702 and the spatial pylon 701 forms a robust and stiff connection structure between the gas turbine engine 300 and an aircraft coupled to the first combined pylon 700. In the illustrated example of FIG. 7A, the partial box pylon 702 is coupled to the top rail 310 of the spatial pylon 701 downstream of the middle frame portion 318. That is, in the illustrated example of FIG. 3A, the partial box pylon 702 is axially aligned with the carcass 322 and the aft frame portion 320. In the illustrated example of FIG. 7A, the partial box pylon 702 extends axially aft from the aft member 704 and the aft frame portion 320. In other examples, the partial box pylon 702 can have other spatial relationships with the gas turbine engine 300 and/or the spatial pylon 701 (e.g., the partial box pylon 702 extends the entire length of the top rail 310, the partial box pylon 702 does not extend axially aft of the aft member 704, etc.). In some examples, the top rail 310 is coupled directly with an aircraft including the first combined pylon 700. In other examples, all load paths between the first combined pylon 700 and the aircraft extend through the partial box pylon 702.

FIG. 7B is a schematic side view of the gas turbine engine 300 of FIG. 3A and an example second combined pylon 706 implemented in accordance with teachings of this disclosure. In the illustrated example of FIG. 7B, the second combined pylon 706 includes a spatial pylon 708, a partial box pylon 710, a middle mount 712, an aft mount 714, and an aft pylon member 716. The spatial pylon 708 is similar to the second spatial pylon 400 of FIG. 4A, except that the spatial pylon 708 does not include features axially aft of the middle frame portion 318 (e.g., the spatial pylon 708 does not include the circumferential members 412, 414 of FIG. 4A, the axial arms 416A, 416B of FIG. 4A, the cross arms 418E, 418F, 418G, 418H of FIG. 4A, etc.) and as otherwise noted.

In the illustrated example of FIG. 7B, the spatial pylon 708 includes a top rail 720, the middle mounts 402A, 402B, 404A, 404B of FIG. 4A, the circumferential members 408, 410 of FIG. 4A, the cross arms 418A, 418B, 418C, 418D of FIG. 4A, and the axial arms 415A, 415B of FIG. 4A. In the illustrated example of FIG. 7B, the top rail 720 extends axially between the front frame portion 316 and the middle frame portion 318. In the illustrated example of FIG. 7B, the top rail 720 is coupled to the circumferential members 408, 410 and the cross arms 418A, 418B, 418C, 418D. In some examples, the top rail 720 is coupled directly with an aircraft including the second combined pylon 706. In other examples, all load paths between the second combined pylon 706 and the aircraft extend through the partial box pylon 710.

The partial box pylon 710 is similar to the partial box pylon 702 of FIG. 7A, except as noted otherwise. In the illustrated example of FIG. 7A, a tip 722 (e.g., a forward end, etc.) of the partial box pylon 710 is coupled to the aft end of the top rail 720. That is, the tip 722 abuts the aft end of the top rail 720. In other examples, the partial box pylon 710 is not coupled to the top rail 720 (e.g., the partial box pylon 710 is not coupled to the spatial pylon 708, the partial box pylon 710 is coupled to another part of the spatial pylon 708, etc.). Unlike the partial box pylon 702 of FIG. 7A, partial box pylon 710 is directly connected to the gas turbine engine 300 via the mounts 712, 714. In some examples, the direct mounting of the gas turbine engine 300 to the second partial box pylon via the mounts 712, 714 reduces the system weight by reducing the number of required members of the spatial pylon 708 compared to the spatial pylon 701 of FIG. 7A, while maintaining the design benefits associated with the spatial pylon 708 (e.g., design flexibility, accessibility, etc.).

The mounts 712, 714 are mechanical linkages that couple the gas turbine engine 300 to the partial box pylon 710. In the illustrated example of FIG. 7B, the aft mount 714 couples the middle frame portion 318 to the partial box pylon 710. In the illustrated example of FIG. 7B, the aft mount 714 couples the aft frame portion 320 to the partial box pylon 710. In some examples, some or all of the mounts 712, 714 be implemented by a pin linkage (e.g., a 1-pin linkage, a lug/clevis linkage, a 2-pin linkage, a 3-pin linkage, etc.), a whiffletree linkage, a slotted oval hole, a bolted joint, a swing linkage, and/or other type of linkage or combination thereof.

In the illustrated example of FIG. 7B, the aft pylon member 716 extends between the partial box pylon 710 and the aft mount 714. In some examples, the aft pylon member 716 is integral (e.g., unitary, monolithic, etc.) with the partial box pylon 710. In other examples, the aft pylon member 716 is coupled to partial box pylon 710 via one or more fasteners, one or more threaded connections, via one or more interference fits, etc. In some examples, the aft pylon member 716 is absent. In some such examples, the gas turbine engine 300 is cantilevered (e.g., similar to the gas turbine engine 600 of FIGS. 6A-6C, etc.). In other examples, the aft mount 714 is coupled directly to the partial box pylon 710.

FIG. 7C is a schematic side view of the gas turbine engine 300 of FIG. 3A and an example third combined pylon 724 implemented in accordance with teachings of this disclosure. In the illustrated example of FIG. 7B, the third combined pylon 724 includes a spatial pylon 726 and a partial box pylon 728. The spatial pylon 726 is similar to the fourth spatial pylon 428 of FIG. 4C, except that the third combined pylon 724 includes the aft member 704 of FIG. 7A and as otherwise noted. Like the fourth spatial pylon 428 of FIG. 4C, the third combined pylon 724 fully constrains the boundary conditions of the gas turbine engine (e.g., the spatial pylon 701 transfers yaw, pitch, and roll loads and moments between the gas turbine engine 300 and the partial box pylon 702, etc.). The partial box pylon 728 is similar to the partial box pylon 702 of FIG. 7A, excepted as noted otherwise. In the illustrated example of FIG. 7C, the partial box pylon 728 is fully integrated with the spatial pylon 701 (e.g., the spatial pylon 701 is fully supported by the partial box pylon 728, etc.). That is, the partial box pylon 728 extends along the entire length of the top rail 720. The integration of the partial box pylon 702 and the spatial pylon 701 forms a robust and stiff connection structure between the gas turbine engine 300 and an aircraft coupled to the first combined pylon 700. Like the fourth spatial pylon 428 of FIG. 4C, the third combined pylon 724 is suitable for use with gas turbine engines with external blades, such as turboprop gas turbine engines and open fan engines.

FIG. 8A is a schematic side view of the gas turbine engine 300 of FIG. 3A, an airframe 800, and an example sixth spatial pylon 802 implemented in accordance with teachings of this disclosure. In some examples, the airframe 800 is a fuselage. In other examples, the airframe 800 can be another part of an aircraft, such as an aircraft tail, an aircraft vertical stabilizer, etc. In the illustrated example of FIG. 8A, the sixth spatial pylon 802 includes a first engine-to-pylon mount 804, a second engine-to-pylon mount 806A, a third engine-to-pylon mount 806B, a fourth engine-to-pylon mount 808, a fifth engine-to-pylon mount 810A, a sixth engine-to-pylon mount 810B, a seventh engine-to-pylon mount 812A, and an eighth engine-to-pylon mount 812B. The first engine-to-pylon mount 804 and the fourth engine-to-pylon mount 808 are similar to the mounts 304, 308 of FIG. 3A, except as noted otherwise. The engine-to-pylon mounts 806A, 806B, 810A, 810B, 812A, 812B are similar to the mounts 402A, 402B, 404A, 404B, 406A, 406B of FIG. 4A, except as noted otherwise.

In the illustrated example of FIG. 8A, the sixth spatial pylon 802 includes a first pylon-to-airframe mount 814A, a second pylon-to-airframe mount 814B, and a third pylon-to-airframe mount 814C. The pylon-to-airframe mounts 814A, 814B, 814C couple the sixth spatial pylon 802 to the airframe 800. In the illustrated example of FIG. 8A, the first pylon-to-airframe mount 814A is axially aligned with the first circumferential member 408 and the first engine-to-pylon mount 804. In the illustrated example of FIG. 8A, the second pylon-to-airframe mount 814B is axially aligned with the second circumferential member 410 and axially forward of the fourth engine-to-pylon mount 808. In the illustrated example of FIG. 8A, the third pylon-to-airframe mount 814C is axially aligned with the fourth circumferential member 414 and the gas turbine engine-to-pylon mounts 812A, 812B. In some examples, the sixth spatial pylon 802 can include additional and/or alternative pylon-to-airframe mounts disposed at other locations on the top rail 816. In some examples, the flexibility of the locations of the pylon-to-airframe mounts 814A, 814B, 814C enables such locations to be selected to reduce core closure in the carcass 322, reduce the weight associated with the sixth spatial pylon 802, and to increase the strength of the sixth spatial pylon 802.

The pylon-to-airframe mounts 814A, 814B, 814C can be implemented by a pin linkage (e.g., a 1-pin linkage, a lug/clevis linkage, a 2-pin linkage, a 3-pin linkage, etc.), a whiffletree linkage, a slotted oval hole, a bolted joint, a swing linkage, and/or other type of linkage or combination thereof. In some examples, the pylon-to-airframe mounts 814A, 814B, 814C are absent. In some such examples, the top rail 816 of the sixth spatial pylon 802 can be coupled to the airframe 800 via one or more welds, via one or more other fasteners, via one or more interference fits, etc.

In the illustrated example of FIG. 8A, the sixth spatial pylon 802 includes the circumferential members 408, 410, 414 of FIG. 4A, the cross arms 418A, 418B, 418C, 418D of FIG. 4A, and the axial arms 415A, 415B of FIG. 4A. Additionally, the sixth spatial pylon 802 includes a top rail 816, a first cross arm 816A, a second cross arm 816B, a third cross arm 816C, a fourth cross arm 816D, a fifth cross arm 816E, a sixth cross arm 816F, a seventh cross arm 816G, and an eighth cross arm 816H. The cross arms 816A, 816B, 816C, 816D, 816E, 816F, 816G, 816H are similar to the cross arms 314A, 314B, 314C, 314D, 314E, 314E, 314F, 314G, 314H, 314I, 314J except as noted otherwise. The cross arms 816A, 816B, 816C, 816D, 816E, 816F, 816G, 816H reinforce the sixth spatial pylon 802. In the illustrated example of FIG. 8A, the cross arms 816A, 816B, 816C, 816D, 816E, 816F, 816G, 816H are disposed axially between the middle frame portion 318 and the aft frame portion 320 (e.g., the cross arms 816A, 816B, 816C, 816D, 816E, 816F, 816G, 816H are axially aligned with the carcass 322, etc.).

In the illustrated example of FIG. 8A, the first cross arm 816A extends between a location of the top rail 816 adjacent to the fourth engine-to-pylon mount 808 and a mid-span location of the third cross arm 816C. In the illustrated example of FIG. 8A, the second cross arm 816B extends between a location of the top rail 816 adjacent to the fourth engine-to-pylon mount 808 and a mid-span location of the fourth cross arm 816D. In the illustrated example of FIG. 8A, the third cross arm 816C extends between the fifth engine-to-pylon mount 810A and a mid-span location of the top rail 816. In the illustrated example of FIG. 8A, the fourth cross arm 816D extends between the sixth engine-to-pylon mount 810B and a mid-span location of the top rail 816. In the illustrated example of FIG. 8A, the fifth cross arm 816E extends between the seventh engine-to-pylon mount 812A and a mid-span location of the top rail 816. In the illustrated example of FIG. 8A, the sixth cross arm 816F extends between the eighth engine-to-pylon mount 812B and a mid-span location of the top rail 816. In the illustrated example of FIG. 8A, the seventh cross arm 816G extends between the fourth circumferential member 414 and a mid-span location of the fifth cross arm 816E. In the illustrated example of FIG. 8A, the eighth cross arm 816G extends between the fourth circumferential member 414 and a mid-span location of the sixth cross arm 816F.

While one example configuration of the sixth spatial pylon 802 is shown in FIG. 8A, it should be appreciated that the sixth spatial pylon 802 can have other configurations of cross-arms, circumferential members, and mounts. For example, the sixth spatial pylon 802 can have a configuration similar to the first spatial pylon 302 of FIGS. 3A and 3B, the second spatial pylon 400 of FIG. 4A, the third spatial pylon 420 of FIG. 4B, the fourth spatial pylon 428, the fifth spatial pylon 500 of FIG. 5, etc. Additionally or alternatively, the sixth spatial pylon 802 can include some or all of the longitudinal harnesses 602A, 602B, 602C, 602D and/or the diagonal harnesses 604A, 604B, 604C, 604D of FIGS. 6A-6C. Additionally or alternatively, the sixth spatial pylon 802 can include a partial box pylon, such as the partial box pylon 702 of FIG. 7A, the partial box pylon 710 of FIG. 7B and/or the third partial box pylon 728 of FIG. 7C.

FIG. 8B is a schematic side view of the gas turbine engine 300 of FIG. 3A, the airframe 800 of FIG. 8A, and an example seventh partial pylon 822 implemented in accordance with teachings of this disclosure. In the illustrated example of FIG. 8B, the seventh partial pylon 822 includes a forward spatial pylon section 824A and an aft spatial pylon section 824B. The forward spatial pylon section 824A is similar to the sixth partial pylon 708 of FIG. 7B, except that the top rail 720 is coupled to the airframe 800 via the pylon-to-airframe mounts 814A, 814B. In other examples, the top rail 720 can be coupled to the airframe 800 via a different quantity of pylon-to-airframe mounts (e.g., one mount, three mounts, etc.). In other examples, the top rail 720 can be coupled to the airframe 800 via one or more welds, one or more interference fits, etc.

In the illustrated example of FIG. 8B, the aft spatial pylon section 824B includes an aft mount 826 that is coupled to the aft frame portion 320. The aft mount 826 is similar to the aft mount 714 of FIG. 7B, except as noted otherwise. In the illustrated example of FIG. 8B, the aft mount 826 is coupled to the airframe 800 via an aft member 828. The aft member 828 is similar to the aft member 311 of FIG. 3A, except as noted otherwise. The aft member 828 is a vertical member that extends vertically between the airframe 800 and the aft mount 826. In some examples, the aft member 828 is coupled to the airframe 800 via one or more welds, via one or more fasteners, via one or more threaded connections, etc. Additionally or alternatively, the aft member 828 can extend partially into an interior of the airframe 800. In other examples, the forward pylon section 824A and/or the aft pylon section 824B can have other spatial configurations of members. Additionally or alternatively, the seventh partial pylon 822 can include other pylon sections in addition to the forward spatial pylon section 824A and the aft spatial pylon section 824B (e.g., three total pylon sections, four total pylon sections, etc.).

From the foregoing, it will be appreciated that spatial pylons for mounting a gas turbine engine are disclosed herein. The spatial pylons disclosed herein reduce system weight, reduce engine footprint, increase ground clearance, and provide reduced core closures when compared to prior box pylons. Example spatial pylons disclosed herein offer additional design flexibility for the placement of engine mounts on the pylon and enable the coupling of pylons to the sides of a gas turbine engine. Example spatial pylons disclosed herein also facilitate the maintenance of gas turbine engines by increasing the ease of removing a gas turbine engine and the ease of accessing the interior of a gas turbine engine.

Further aspects of the disclosure are provided by the subject matter of the following clauses:

An example apparatus to couple a gas turbine engine relative to a wing of an aircraft, the apparatus including: a first mount coupled to a first frame portion of the gas turbine engine; a second mount coupled to a second frame portion of the gas turbine engine; a third mount coupled to the gas turbine engine; a main rail extending between the first mount and the second mount; and a circumferential member coupled to the main rail and the third mount.

The apparatus of any preceding clause, further including a fourth mount coupled to the circumferential member and to the gas turbine engine.

The apparatus of any preceding clause, wherein the third mount and the fourth mount have a same angular displacement from the main rail.

The apparatus of any preceding clause, further including an axial arm extending between the third mount and the first mount.

The apparatus of any preceding clause, wherein the circumferential member is a first circumferential member and the apparatus further including: a fourth mount coupled to the gas turbine engine; a second circumferential member coupled to the main rail and the fourth mount; and a second member extending between the third mount and the fourth mount.

The apparatus of any preceding clause, wherein the third mount and the fourth mount have a same displacement from the main rail.

The apparatus of any preceding clause, further including a harness to extend between the first frame portion and the second frame portion.

The apparatus of any preceding clause, further including a partial box pylon to be coupled to the aircraft, the partial box pylon coupled to the main rail.

The apparatus of any preceding clause, wherein the main rail is to be coupled to a tip of the partial box pylon.

The apparatus of any preceding clause, wherein the first frame portion is a forward frame portion, the second frame portion is a middle frame portion, and the apparatus further includes: a fourth mount coupled to a rear frame portion; a vertical member coupled to the fourth mount and the aircraft.

A gas turbine engine including: a first frame portion; a second frame portion; and a spatial pylon to couple the gas turbine engine to an aircraft, the spatial pylon including: a first mount coupled to the first frame portion; a second mount coupled to the second frame portion; a third mount; a main rail extending between the first mount and the second mount; and a circumferential member coupled to the main rail and the third mount.

The gas turbine engine of any preceding clause, wherein the spatial pylon further includes a fourth mount coupled to the circumferential member.

The gas turbine engine of any preceding clause, wherein the third mount and the fourth mount are disposed at a same relative height on the gas turbine engine.

The gas turbine engine of any preceding clause, wherein the spatial pylon includes at least four cross arms.

The gas turbine engine of any preceding clause, wherein the circumferential member is a first circumferential member and the spatial pylon further includes: a fourth mount; and a second circumferential member coupled to the fourth mount.

The gas turbine engine of any preceding clause, wherein the spatial pylon further includes a member extending between the third mount and the fourth mount.

The gas turbine engine of any preceding clause, further including a harness to extend between the first frame portion and the second frame portion.

The gas turbine engine of any preceding clause, further including a box pylon coupled to the main rail.

The gas turbine engine of any preceding clause, wherein the main rail abuts a tip of the box pylon.

The gas turbine engine of any preceding clause, wherein the first frame portion is a forward frame portion, the second frame portion is a middle frame portion, and the gas turbine engine further includes: a fourth mount coupled to an aft frame portion; an aft member coupled to the fourth mount and the aircraft, the aft member extending vertically between the aircraft and the aft frame portion.

The apparatus of any preceding clause, wherein the gas turbine engine is an unducted engine.

The apparatus of any preceding clause, wherein the gas turbine engine is a ducted engine.

The gas turbine engine of any preceding clause, wherein the gas turbine engine is an unducted engine.

The gas turbine engine of any preceding clause, wherein the gas turbine engine is a ducted engine.

The following claims are hereby incorporated into this Detailed Description by this reference, with each claim standing on its own as a separate embodiment of the present disclosure.

What is claimed is:

1. An apparatus to couple a gas turbine engine relative to a wing of an aircraft, the apparatus including:
a first mount coupled to a first frame portion of the gas turbine engine;
a second mount coupled to a second frame portion of the gas turbine engine;
a third mount coupled to the gas turbine engine;
a main rail extending between the first mount and the second mount; and
a circumferential member coupled to the main rail and the third mount.

2. The apparatus of claim 1, further including a fourth mount coupled to the circumferential member and to the gas turbine engine.

3. The apparatus of claim 2, wherein the third mount and the fourth mount have a same angular displacement from the main rail.

4. The apparatus of claim 1, further including an axial arm extending between the third mount and the first mount.

5. The apparatus of claim 1, wherein the circumferential member is a first circumferential member and the apparatus further including:
a fourth mount coupled to the gas turbine engine;
a second circumferential member coupled to the main rail and the fourth mount; and
a second member extending between the third mount and the fourth mount.

6. The apparatus of claim 5, wherein the third mount and the fourth mount have a same displacement from the main rail.

7. The apparatus of claim 6, further including a harness to extend between the first frame portion and the second frame portion.

8. The apparatus of claim 1, further including a partial box pylon to be coupled to the aircraft, the partial box pylon coupled to the main rail.

9. The apparatus of claim 8, wherein the main rail is to be coupled to a tip of the partial box pylon.

10. The apparatus of claim 1, wherein the first frame portion is a forward frame portion, the second frame portion is a middle frame portion, and the apparatus further includes:
a fourth mount coupled to a rear frame portion; and
a vertical member coupled to the fourth mount and the aircraft.

11. A gas turbine engine including:
a first frame portion;
a second frame portion; and
a spatial pylon to couple the gas turbine engine to an aircraft, the spatial pylon including:
a first mount coupled to the first frame portion;
a second mount coupled to the second frame portion;
a third mount;
a main rail extending between the first mount and the second mount; and
a circumferential member coupled to the main rail and the third mount.

12. The gas turbine engine of claim 11, wherein the spatial pylon further includes a fourth mount coupled to the circumferential member.

13. The gas turbine engine of claim 12, wherein the third mount and the fourth mount are disposed at a same relative height on the gas turbine engine.

14. The gas turbine engine of claim 11, wherein the spatial pylon includes at least four cross arms.

15. The gas turbine engine of claim 11, wherein the circumferential member is a first circumferential member and the spatial pylon further includes:
a fourth mount; and
a second circumferential member coupled to the fourth mount.

16. The gas turbine engine of claim 15, wherein the spatial pylon further includes a member extending between the third mount and the fourth mount.

17. The gas turbine engine of claim 11, further including a harness to extend between the first frame portion and the second frame portion.

18. The gas turbine engine of claim 11, further including a box pylon coupled to the main rail.

19. The gas turbine engine of claim 18, wherein the main rail abuts a tip of the box pylon.

20. The gas turbine engine of claim 11, wherein the first frame portion is a forward frame portion, the second frame portion is a middle frame portion, and the gas turbine engine further includes:
a fourth mount coupled to an aft frame portion; and
an aft member coupled to the fourth mount and the aircraft, the aft member extending vertically between the aircraft and the aft frame portion.
